(19) United States
(12) Patent Application Publication
(10) Pub. No.: US 2021/0107829 A1
(43) Pub. Date: Apr. 15, 2021

(54) METHODS OF MAKING A FOLDABLE APPARATUS

(71) Applicant: CORNING INCORPORATED, CORNING, NY (US)

(72) Inventors: Naigeng Chen, San Jose, CA (US); Matthew Wade Fenton, Elmira, NY (US); Timothy Michael Gross, Corning, NY (US); Yuhui Jin, Painted Post, NY (US); Xinghua Li, Horseheads, NY (US); Yousef Kayed Qaroush, Painted Post, NY (US); Lei Yuan, Painted Post, NY (US)

(21) Appl. No.: 17/068,158

(22) Filed: Oct. 12, 2020

Related U.S. Application Data
(60) Provisional application No. 62/914,762, filed on Oct. 14, 2019.
(60) Provisional application No. 62/914,746, filed on Oct. 14, 2019.

(51) Int. Cl. C03C 23/00; C03C 17/00

(52) U.S. Cl. CPC C03C 23/0025; C03B 17/064; C03C 17/002

(57) ABSTRACT

Foldable apparatus can comprise a foldable substrate comprising a thickness (T) and a plurality of grooves extending through a first major surface. A groove spacing (Gs) is defined between a pair of grooves. A first groove of the plurality of grooves comprises a groove depth (Gd) and a groove width (Gw). In some embodiments, 7.93-6.19*(Gw/T) −9.52*(Gd/T) +6.05*(Gs/T) <0. In some embodiments, (Gw/T) ≥0.1, (Gs/T) ≤1.5, 0.3≤Gd/T 0.95. In some embodiments, a combined groove volume divided by a central volume can be about 0.3 or more. Methods of making a foldable apparatus comprise drawing a ribbon from a quantity of molten material off a forming device. Methods further comprising impinging a target location of the ribbon traveling in a draw direction with a laser beam to form a groove in the ribbon. In some embodiments, the groove can comprise a plurality of grooves.

### RELATED APPLICATIONS

This application claims the benefit of priority under 35 U.S.C. § 119 of U.S. Provisional Application Ser. No. 62/914762 filed on Oct. 14, 2019 and U.S. Provisional Application Ser. No. 62/914746 filed on Oct. 14, 2019, the contents of each of which are relied upon and incorporated herein by reference in their entireties.

### FIELD

The present disclosure relates generally to foldable apparatus and methods of making and, more particularly, to foldable apparatus comprising a foldable substrate and methods of making foldable apparatus.

### BACKGROUND

Glass-based substrates are commonly used, for example, in display applications, for example, liquid crystal displays (LCDs), electrophoretic displays (EPD), organic light emitting diode displays (OLEDs), plasma display panels (PDPs), or the like. Such displays can be incorporated, for example, into mobile phones, tablets, laptops, watches, wearables, and/or touch-capable monitors or displays.

It is known to form grooves in a glass-based substrate by ablating the glass-based substrate with a laser. Once the grooves are formed, the glass-based substrate can comprise a foldable glass-based substrate that can fold along a fold axis due to the laser-formed grooves. However, ablating the glass-based substrate can result in surface damage to the glass-based substrate in the vicinity of the grooves. The surface damage can act as points of crack failure when folding the glass-based substrate and therefore limit the foldability of the glass-based substrate. Furthermore, forming the grooves in the glass-based substrate can be time-consuming and involve multiple steps.

There is a desire to develop foldable versions of displays as well as foldable protective covers to mount on foldable displays. Foldable displays and covers should have good impact and puncture resistance. At the same time, foldable displays and covers should have small minimum bend radii (e.g., about 10 millimeters (mm) or less). However, plastic displays and covers with small minimum bend radii tend to have poor impact and/or puncture resistance. Furthermore, conventional wisdom suggests that ultra-thin glass-based sheets (e.g., about 75 micrometers (μm or microns) or less thick) with small minimum bend radii tend to have poor impact and/or puncture resistance. Furthermore, thicker glass-based sheets (e.g., greater than 125 micrometers) with good impact and/or puncture resistance tend to have relatively large minimum bend radii (e.g., about 30 millimeters or more). Consequently, there is a need to develop foldable substrates (e.g., foldable glass-based substrates, foldable ceramic-based substrates) for foldable apparatus that have low minimum bend radii and good impact and puncture resistance.

### SUMMARY

There are set forth herein foldable apparatus and methods of making foldable apparatus that comprise foldable substrates. Apparatus according to embodiments of the disclosure can provide several technical benefits. Apparatus comprising a plurality of grooves in a foldable substrate according to embodiments of the disclosure can reduce bend-induced stresses on the foldable substrate compared to a corresponding foldable substrate without grooves. Reduced bend-induced stresses can provide the technical benefit of increased folding performance, for example, achieving lower effective minimum bend radii (e.g., about 10 millimeters or less). Reduced bend-induced stresses can facilitate the use of thicker foldable substrates that obtain a predetermined effective bend radius, which can enable good impact and/or puncture resistance. Providing a plurality of grooves comprising a ratio (Gs/T) of about 1.5 or less, a ratio (Gd/T) in a range from about 0.3 to about 0.95, a ratio (Gw/T) of about 0.3 or more, or combinations thereof can provide reduced bend-induced stresses. Providing a plurality of grooves in a foldable substrate satisfying the expression 7.93-6.19*(Gw/T) −9.52*(Gd/T) +6.05*(Gs/T) <0 can provide bend-induced stress reductions. Providing a plurality of grooves such that a ratio (Vg/Vc) of the combined groove volume to the central volume of about 0.3 or more can provide bend-induced stress reductions. Additionally, chemically strengthening the foldable substrate (e.g., central portion of the substrate) can provide the technical benefit of improved effective minimum bend radii and/or reduced damages (e.g., breakage and/or cracking) of the foldable apparatus because the compressive stress from chemical strengthening can counteract tensile bend-induced forces. Also, providing a central portion with the second thickness and a width that is about 3 times or more (e.g., 4.4 times) the effective minimum bend radius (e.g., bend length) or more can reduce stress concentrations and damage to the foldable apparatus. Matching (e.g., within about 0.1) the index of refraction of the optically clear adhesive to the index of refraction of the foldable substrate can minimize optical distortions in the foldable apparatus.

Also, methods of making a foldable apparatus can reduce or eliminate surface damage in a substrate (e.g., a glass-based and/or a ceramic-based substrate) that may otherwise be formed with conventional techniques. In some embodiments, ablation of the substrate to form the grooves can be carried out by impinging a target location of the substrate with a laser beam, wherein the target location of the substrate is at a heated temperature of 500 degrees Celsius (° C.) or more when initially beginning to impinge the target location with the laser beam. The heated temperature of the substrate can help partially or completely heal surface damage caused by the laser ablation procedure since the heated temperature of the target location at the time the laser ablation occurs can allow portions of the substrate to flow to partially or entirely erase and/or heal and/or reduce the surface damage or other residual imperfections caused by the laser ablation process. In addition, the groove(s) can be formed in-line with a method of forming a ribbon to reduce the steps to form the grooves. Furthermore, as the groove(s) are formed in-line with the ribbon-forming process, in some embodiments, rather than separating single foldable substrates from the ribbon after forming the groove(s), a single ribbon can be rolled into a storage roll with the grooves already formed in the ribbon. Later, the ribbon may be unwound from the storage roll and separated into individual foldable substrates. A single storage roll may, therefore, be easily stored where the individual foldable substrates may then be separated from the ribbon unwound from the storage roll when desired. Furthermore, when unwinding the ribbon, the number of central portions may be selected for each individual foldable substrate at the time of unwinding the ribbon from the storage roll. As such, a bifold foldable substrate, trifold foldable substrate, or other foldable substrate arrangements may be selected at the time of unwinding the ribbon from the storage roll.

Some example embodiments of the disclosure are described below with the understanding that any of the features of the various embodiments may be used alone or in combination with one another.

Embodiment 1. A foldable apparatus comprises a foldable substrate foldable about an axis extending in a direction of a width of the foldable substrate.

The foldable substrate further comprises a first major surface, a second major surface, and a thickness (T) defined between the first major surface and the second major surface. The foldable substrate further comprises a central portion comprising a plurality of grooves extending through the first major surface. The foldable substrate further comprises a groove spacing (Gs) defined between a pair of grooves of the plurality of grooves. The foldable substrate further comprises a first groove of the plurality of grooves comprising a groove depth (Gd) in a direction of the thickness (T), a groove length in the direction of the width of the foldable substrate, and a groove width (Gw) in a direction of a length of the foldable substrate that is perpendicular to the width of the foldable substrate. 7.93-6.19*(Gw/T) −9.52 * (Gd/T) +6.05 * (Gs/T) <0.

Embodiment 2. The foldable apparatus of embodiment 1, wherein the ratio (Gw/T) is about 0.1 or more.

Embodiment 3. The foldable apparatus of any one of embodiments 1-2, wherein the ratio (Gs/T) is about 1.5 or less.

Embodiment 4. The foldable apparatus of any one of embodiments 1-3, wherein the ratio (Gd/T) is in a range from about 0.3 to about 0.95.

Embodiment 5. A foldable apparatus comprises a foldable substrate foldable about an axis extending in a direction of a width of the foldable substrate. The foldable substrate further comprises a first major surface, a second major surface, and a thickness (T) defined between the first major surface and the second major surface. The foldable substrate further comprises a central portion comprising a plurality of grooves extending through the first major surface. The foldable substrate further comprises a groove spacing (Gs) defined between a pair of grooves of the plurality of grooves. The foldable substrate further comprises a first groove of the plurality of grooves comprising a groove depth (Gd) in a direction of the thickness (T), a groove length in the direction of the width of the foldable substrate, and a groove width (Gw) in a direction of a length of the foldable substrate that is perpendicular to the width of the foldable substrate. A ratio (Gw/T) of the groove width (Gw) to the thickness (T) is about 0.1 or more. A ratio (Gs/T) of the groove spacing (Gs) to the thickness (T) is about 1.5 or less. A ratio (Gd/T) of the groove depth (Gd) to the thickness (T) is in a range from about 0.3 to about 0.95.

Embodiment 6. The foldable apparatus of any one of embodiments 1-5, wherein the first major surface extends along a first plane and the second major surface extends along a second plane parallel to the first plane. The foldable apparatus further comprises a combined groove volume (Vg) comprising a sum of a volume of each groove of the plurality of grooves bounded by the first plane and circumscribed by the outer periphery of the central portion. The foldable apparatus further comprises a central volume (Vc) defined between the first plane and the second plane and circumscribed by an outer periphery of the central portion. A ratio (Vg/Vc) of the combined groove volume (Vg) to the central volume (Vc) is about 0.3 or more.

Embodiment 7. A foldable apparatus comprises a foldable substrate foldable about an axis extending in a direction of a width of the foldable substrate. The foldable substrate further comprises a first major surface extending along a first plane, a second major surface extending along a second plane parallel to the first plane, and a thickness (T) defined between the first major surface and the second major surface. The foldable substrate further comprises a central portion comprising a plurality of grooves extending through the first major surface. The foldable substrate further comprises a groove spacing (Gs) defined between a pair of grooves of the plurality of grooves. The foldable substrate further comprises a first groove of the plurality of grooves comprising a groove depth (Gd) in a direction of the thickness (T), a groove length in the direction of the width of the foldable substrate, and a groove width (Gw) in a direction of a length of the foldable substrate that is perpendicular to the width of the foldable substrate. The foldable substrate further comprises a combined groove volume (Vg) comprising a sum of a volume of each groove of the plurality of grooves bounded by the first plane and circumscribed by the outer periphery of the central portion. The foldable substrate further comprises a central volume (Vc) defined between the first plane and the second plane and circumscribed by an outer periphery of the central portion. A ratio (Vg/Vc) of the combined groove volume (Vg) to the central volume (Vc) is about 0.3 or more.

Embodiment 8. The foldable apparatus of any one of embodiments 6-7, wherein the ratio (Vg/Vc) is in a range from about 0.3 to about 0.6.

Embodiment 9. The foldable apparatus of any one of embodiments 1-8, wherein the first groove is substantially straight.

Embodiment 10. The foldable apparatus of any one of embodiments 1-9, wherein the first groove comprises a cross-sectional profile taken perpendicular to the groove length that is substantially identical at ten (10) locations equidistantly spaced along the entire groove length.

Embodiment 11. The foldable apparatus of any one of embodiments 1-10, wherein the first groove is substantially parallel to a second groove of the plurality of grooves.

Embodiment 12. The foldable apparatus of any one of embodiments 1-11, wherein the thickness (T) is in a range from about 100 micrometers to about 3 millimeters.

Embodiment 13. The foldable apparatus of any one of embodiments 1-12, wherein the first groove is defined by a groove surface. A minimum distance between the groove surface and the second major surface is in a range from about 20 micrometers to about 100 micrometers.

Embodiment 14. The foldable apparatus of any one of embodiments 1-13, wherein each groove of the plurality of grooves comprises substantially the same groove depth (Gd).

Embodiment 15. The foldable apparatus of any one of embodiments 1-14, wherein the groove width (Gw) is in a range from about 20 micrometers to about 200 micrometers.

Embodiment 16. The foldable apparatus of any one of embodiments 1-15, wherein each groove of the plurality of grooves comprises substantially the same groove width (Gw).

Embodiment 17. The foldable apparatus of any one of embodiments 1-16, wherein the groove length is equal to the width of the foldable substrate.

Embodiment 18. The foldable apparatus of any one of embodiments 1-17, wherein each groove of the plurality of grooves comprises substantially the same groove length.

Embodiment 19. The foldable apparatus of any one of embodiments 1-18, wherein the plurality of grooves comprise substantially identical grooves.

Embodiment 20. The foldable apparatus of any one of embodiments 1-19, wherein the foldable substrate comprises a ceramic-based substrate.

Embodiment 21. The foldable apparatus of any one of claims 1-19, wherein the foldable substrate comprises a glass-based substrate.

Embodiment 22. The foldable apparatus of embodiment 20 or 21, wherein the foldable substrate comprises a second compressive stress region extending from the second major surface to a second depth of compression.

Embodiment 23. The foldable apparatus of embodiment 22, wherein the foldable substrate comprises a first compressive stress region extending from the first major surface to a first depth of compression.

Embodiment 24. The foldable apparatus of embodiment 23, wherein a maximum compressive stress of the first compressive stress region is in a range from about 200 MegaPascals to about 1,500 MegaPascals. A maximum compressive stress of the second compressive stress region is in a range from about 200 MegaPascals to about 1,500 MegaPascals.

Embodiment 25. The foldable apparatus of embodiment 24, wherein the maximum stress of the first compressive stress region is substantially equal to the maximum stress of the second compressive stress region.

Embodiment 26. The foldable apparatus of any one of embodiments 23-25, wherein the first depth of compression is in a range from about 10% to about 30% of the thickness (T). The second depth of compression is in a range from about 10% to about 30% of the thickness (T).

Embodiment 27. The foldable apparatus of embodiment 26, wherein the first depth of compression is substantially equal to the second depth of compression.

Embodiment 28. The foldable apparatus of any one of embodiments 1-27, wherein the foldable substrate comprises an effective minimum bend radius in a range from about 1 millimeter to about 10 millimeters.

Embodiment 29. The foldable apparatus of embodiment 28, wherein the foldable substrate achieves an effective bend radius of 5 millimeters.

Embodiment 30. The foldable apparatus of any one of embodiments 1-29, wherein a central width of the central portion the direction of the length of the foldable substrate is in a range from about 0.5 millimeters to about 50 millimeters.

Embodiment 31. The foldable apparatus of any one of embodiments 1-30, further comprising an optically clear adhesive comprising a first contact surface contacting the first major surface and the optically clear adhesive fills the first groove.

Embodiment 32. The foldable apparatus of embodiment 31, wherein a magnitude of a difference between an index of refraction of the foldable substrate and an index of refraction of the optically clear adhesive is about 0.1 or less.

Embodiment 33. The foldable apparatus of any one of embodiments 30-32, a release liner contacts a second contact surface of the optically clear adhesive opposite the first contact surface of the optically clear adhesive.

Embodiment 34. The foldable apparatus of any one of embodiments 30-32, a display device contacts a second contact surface of the optically clear adhesive opposite the first contact surface of the optically clear adhesive.

Embodiment 35. A consumer electronic product, comprising a housing comprising a front surface, a back surface, and side surfaces. The consumer electronic product comprising electrical components at least partially within the housing, the electrical components comprising a controller, a memory, and a display, the display at or adjacent the front surface of the housing. The consumer electronic product comprising a cover substrate disposed over the display. At least one of a portion of the housing or the cover substrate comprises the foldable apparatus of any one of embodiments 1-34.

Embodiment 36. A method of making a foldable apparatus comprises drawing a ribbon from a quantity of molten material off a forming device to travel in a draw direction. The method further comprises emitting a laser beam from a laser and impinging a target location of the ribbon traveling in the draw direction with the laser beam to form a groove in the ribbon. The ribbon forms a foldable substrate comprising the groove. A thickness of the foldable substrate is defined between a first major surface of the foldable substrate and a second major surface of the foldable substrate opposite the first major surface. The groove of the foldable substrate comprises a groove depth in a direction of the thickness, the groove depth is in a range from about 10 microns to about 95% of the thickness of the foldable substrate.

Embodiment 37. The method of embodiment 36, wherein forming the groove comprises forming a plurality of grooves. The impinging the target location comprises impinging a plurality of target locations of the ribbon with the laser beam.

Embodiment 38. The method of embodiment 37, wherein the laser beam comprises a plurality of laser beams. Each laser beam of the plurality of laser beams impinges a corresponding target location of the plurality of target locations during impinging the target location.

Embodiment 39. The method of any one of embodiments 36-38, wherein forming the groove comprises scanning the laser beam in a direction transverse to the draw direction.

Embodiment 40. The method of any one of embodiments 36-39, wherein the target location comprises a temperature of 500 degrees Celsius (° C.) or more when initially beginning to impinge the target location with the laser beam.

Embodiment 41. The method of any one of embodiments 36-40, wherein the laser beam comprises a wavelength in a range from about 1 micrometer (μm or micron) to about 20 micrometers.

Embodiment 42. The method of any one of embodiments 36-41, wherein the laser comprises a carbon dioxide (CO₂) laser or a carbon monoxide (CO) laser.

Embodiment 43. The method of any one of embodiments 36-42, further comprising contacting the ribbon with pull rollers to draw the ribbon. The target location is positioned between the forming device and the pull rollers during impinging the target location.

Embodiment 44. The method of any one of embodiments 36-43, wherein the target location of the ribbon comprises a viscosity in a range from about 10³ Pascal-seconds to about 10^{6.6} Pascal-seconds when initially beginning to impinge the target location with the laser beam.

Embodiment 45. The method of any one of embodiments 36-43, wherein impinging the target location with the laser beam decreases a thickness of the ribbon at the target location by decreasing a viscosity of the target location.

Embodiment 46. The method of any one of embodiments 36-40, wherein the target location of the ribbon comprises a viscosity in a range from about 10¹¹ Pascal-seconds to about 10¹⁴ Pascal-seconds when initially beginning to impinge the target location with the laser beam.

Embodiment 47. The method of any one of embodiments 36-40 or 46 inclusive, further comprising contacting the ribbon with pull rollers to draw the ribbon. The pull rollers are positioned between the target location and the forming device.

Embodiment 48. The method of any one of embodiments 36-40 or 46-47 inclusive, wherein impinging the target location with the laser beam ablates the ribbon at the target location to form the groove.

Embodiment 49. The method of any one of embodiments 36-48, further comprising contacting a first contact surface of an optically clear adhesive with the first major surface.

Embodiment 50. The method of embodiment 49, wherein the optically clear adhesive fills the groove.

Embodiment 51. The method of any one of embodiments 49-50, further comprising bonding a display device to a second contact surface of the optically clear adhesive.

Embodiment 52. The method of any one of embodiments 49-50, further comprising bonding a release liner to a second contact surface of the optically clear adhesive.

Embodiment 53. The method of any one of embodiments 36-52, further comprising chemically strengthening the foldable substrate.

Embodiment 54. The method of any one of embodiments 36-53, wherein the foldable substrate comprises a ceramic-based substrate.

Embodiment 55. The method of any one of embodiments 36-53, wherein the foldable substrate comprises a glass-based substrate.

Embodiment 56. A method of making a foldable apparatus comprises heating a ribbon to a heated temperature of 500 degrees Celsius (° C.) or more. The method further comprises emitting a laser beam from a laser and impinging a target location of the ribbon with the laser beam to form a groove in the ribbon. The ribbon forms a foldable substrate, and the target location of the foldable substrate is at the heated temperature when initially beginning to impinge the target location with the laser beam. A thickness of the foldable substrate is defined between a first major surface of the foldable substrate and a second major surface of the foldable substrate opposite the first major surface. The groove of the foldable substrate comprises a groove depth in a direction of the thickness, the groove depth is in a range from about 10 microns to about 95% of the thickness of the foldable substrate.

Embodiment 57. The method of embodiment 56, wherein forming the groove comprises forming a plurality of grooves and impinging the target location comprises impinging a plurality of target locations of the ribbon with the laser beam.

Embodiment 58. The method of embodiment 57, wherein the laser beam comprises a plurality of laser beams. Each laser beam of the plurality of laser beams impinges a corresponding target location of the plurality of target locations during impinging the target location.

Embodiment 59. The method of any one of embodiments 56-58, wherein the target location of the ribbon comprises a viscosity in a range from about 10¹¹ Pascal-seconds to about 10¹⁴ Pascal-seconds when initially beginning to impinge the target location with the laser beam.

Embodiment 60. The method of any one of embodiments 56-59, wherein impinging the target location with the laser beam ablates the ribbon at the target location to form the groove.

Embodiment 61. The method of any one of embodiments 56-60, further comprising contacting a first contact surface of an optically clear adhesive with the first major surface.

Embodiment 62. The method of embodiment 61, wherein the optically clear adhesive fills the groove.

Embodiment 63. The method of any one of embodiments 61-62, further comprising bonding a display device to a second contact surface of the optically clear adhesive.

Embodiment 64. The method of any one of embodiments 61-62, further comprising bonding a release liner to a second contact surface of the optically clear adhesive.

Embodiment 65. The method of any one of embodiments 56-64, further comprising chemically strengthening the foldable substrate.

Embodiment 66. The method of any one of embodiments 56-65, wherein the foldable substrate comprises a ceramic-based substrate.

Embodiment 67. The method of any one of embodiments 56-65, wherein the foldable substrate comprises a glass-based substrate.

### BRIEF DESCRIPTION OF THE DRAWINGS

The above and other features and advantages of embodiments of the present disclosure are better understood when the following detailed description is read with reference to the accompanying drawings, in which:

FIG. 1 schematically illustrates apparatus for making a foldable apparatus in accordance with some embodiments of the disclosure;

FIG. 2 shows a cross-sectional view of the apparatus taken along lines 2-2 of FIG. 1;

FIG. 3 is an enlarged view 3 of FIG. 2;

FIG. 4 is further apparatus for making a foldable apparatus in accordance with some further embodiments of the disclosure;

FIG. 5 illustrates a cross-sectional view of embodiments of the apparatus taken along lines 5-5 of FIGS. 2-4 in accordance with some embodiments of the disclosure;

FIG. 6 illustrates another cross-sectional view of further embodiments of the apparatus taken along lines 5-5 of FIGS. 2-4 in accordance with some embodiments of the disclosure;

FIG. 7 illustrates still another cross-sectional view of further embodiments of the apparatus taken along lines 5-5 of FIGS. 2-4 in accordance with some embodiments of the disclosure;

FIG. 8 is a top plan view of example embodiments of foldable substrates made by methods of the disclosure;

FIG. 9 is an end view of the foldable substrates along line 9-9 of FIG. 8;

FIG. 10 is a cross-sectional view of example embodiments of foldable apparatus made by methods of the disclosure;

FIG. 11 is a cross-sectional view of further example embodiments of foldable apparatus made by methods of the disclosure;

FIG. 12 is a plot illustrating a stress ratio as a function of a ratio of the combined groove volume to the central volume;

FIG. 13 is a plot illustrating stress change as a function of groove depth and groove width for a groove spacing to thickness ratio of 0.13;

FIG. 14 is a plot illustrating stress change as a function of groove depth and groove width for a groove spacing to thickness ratio of 0.33;

FIG. 15 is a plot illustrating stress change as a function of groove depth and groove width for a groove spacing to thickness ratio of 0.67;

FIG. 16 is a plot illustrating stress change as a function of groove depth and groove width for a groove spacing to thickness ratio of 1.00;

FIG. 17 is a plot illustrating stress change as a function of groove depth and groove width for a groove spacing to thickness ratio of 1.33;

FIG. 18 is a plot illustrating a stress ratio as a function of a ratio of the groove width to the thickness for a groove spacing to thickness ratio of 0.133;

FIG. 19 is a plot illustrating a stress ratio as a function of a ratio of the groove width to the thickness for a groove spacing to thickness ratio of 1.33;

FIG. 20 is a flow chart illustrating example methods of a forming glass-based ribbon comprising a groove in accordance with embodiments of the disclosure;

FIG. 21 is a top plan view of further example embodiments of foldable substrates made by methods of the disclosure;

FIG. 22 is an end view of the foldable substrates along line 22-22 of FIG. 21;

FIG. 23 is an impact apparatus for failure mode testing;

FIG. 24 is a cross-sectional view of example embodiments of foldable apparatus made by methods of the disclosure;

FIG. 25 is a schematic plan view of an example consumer electronic device according to some embodiments; and

FIG. 26 is a schematic perspective view of the example consumer electronic device of FIG. 25.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, claims may encompass many different aspects of various embodiments and should not be construed as limited to the embodiments set forth herein.

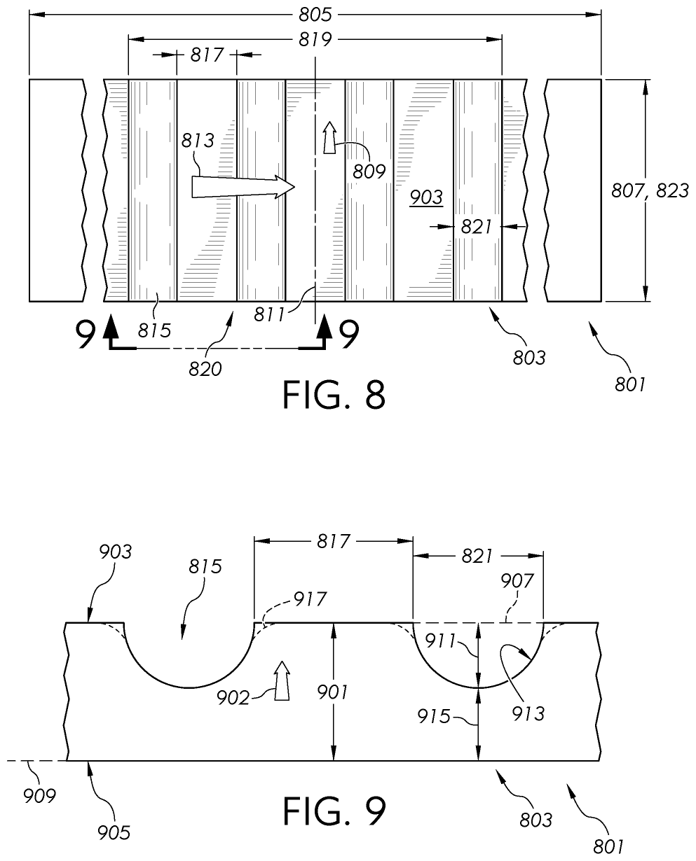

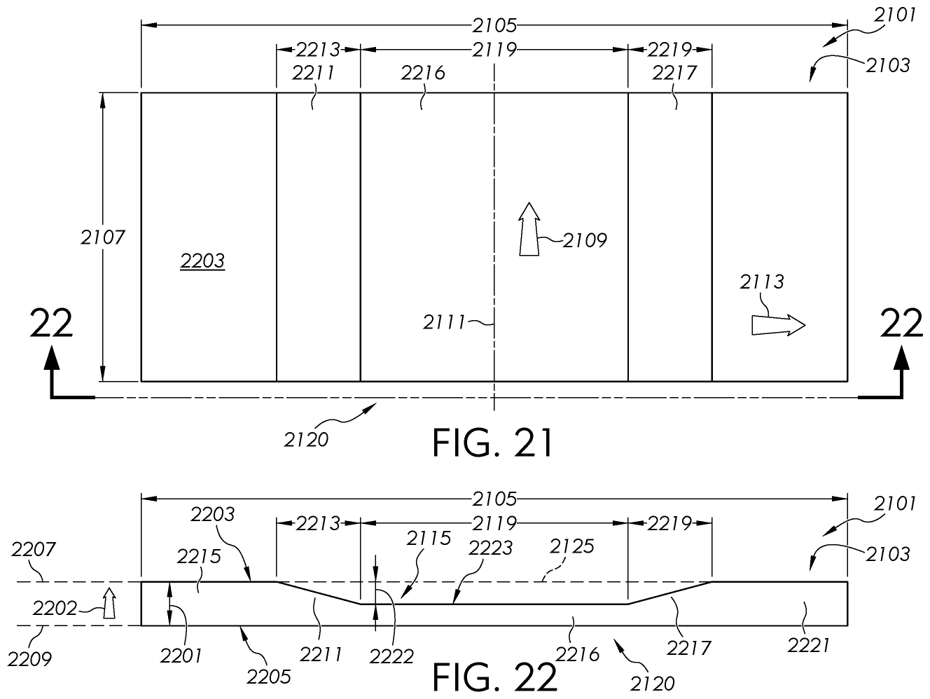

FIGS. 8-11 illustrate views of foldable apparatus 801, 1001, and 1101 in accordance with embodiments of the disclosure, and FIGS. 21-24 illustrate views of foldable apparatus 2101, 2302, and 2401 in accordance with embodiments of the disclosure. Unless otherwise noted, a discussion of features of embodiments of one foldable apparatus can apply equally to corresponding features of any embodiments of the disclosure. For example, identical part numbers throughout the disclosure can indicate that, in some embodiments, the identified features are identical to one another and that the discussion of the identified feature of one embodiment, unless otherwise noted, can apply equally to the identified feature of any of the other embodiments of the disclosure.

In some embodiments, as shown in FIGS. 8-11, the foldable apparatus 801, 1001, and 1101 can comprise a foldable substrate 803. In some embodiments, as shown in FIGS. 21-24, the foldable apparatus 2101 can comprise a foldable substrate 2103. In some embodiments, the foldable substrate 803 and/or 2103 may be a glass-based substrate and/or a ceramic-based substrate having a pencil hardness of 8H or more, for example 9H or more.

Throughout the disclosure, a “glass-based” material is considered a material that can cool or has already cooled into a glass, glass-ceramic, and/or that upon further processing becomes a glass-ceramic material. Glass-ceramics have one or more crystalline phases and an amorphous, residual glass phase. A glass-based material may comprise an amorphous material (e.g., glass) and optionally one or more crystalline materials (e.g., ceramic). Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In one or more embodiments, a glass-based material may comprise, in mole percent (mol %): SiO₂ in a range from about 40 mol % to about 80%, Al₂O₃ in a range from about 10 mol % to about 30 mol %, B₂O₃ in a range from 0 mol % to about 10 mol %, ZrO₂ in a range from 0 mol% to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, a glass-based substrate may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In some embodiments, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spoudumene, cordierite, petalite, and/or lithium disilicate. The glass-ceramic substrates may be strengthened using chemical strengthening processes. In one or more embodiments, MAS-System glass-ceramic substrates may be strengthened in Li₂SO₄ molten salt, whereby an exchange of 2Li⁺ for Mg²⁺ can occur.

Throughout the disclosure, a “ceramic-based” material includes both ceramics and glass-ceramics, wherein glass-ceramics have one or more crystalline phases and an amorphous, residual glass phase. In some embodiments, a ceramic-based material can be formed by heating a glass-based material to form ceramic (e.g., crystalline) portions. In further embodiments, ceramic-based materials may comprise one or more nucleating agents that can facilitate the formation of crystalline phase(s). In some embodiments, the ceramic-based materials can comprise one or more oxide, nitride, oxynitride, carbide, boride, and/or silicide. Example embodiments of ceramic oxides include zirconia (ZrO₂), zircon zirconia (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxide, beryllium oxide, vanadium oxide (VO₂), fused quartz, mullite (a mineral comprising a combination of aluminum oxide and silicon dioxide), and spinel (MgAl₂O₄). Example embodiments of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example embodiments of oxynitride ceramics include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example embodiments of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example embodiments of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example embodiments of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

Throughout the disclosure, a “ribbon” includes a ribbon that has cooled into a glass or glass-ceramic ribbon or comprises a ribbon that, once cooled to room temperature, is in the form of a glass or glass-ceramic ribbon. Furthermore, throughout the disclosure, a “foldable substrate” is considered a glass-based ribbon and/or a ceramic-based ribbon with one or more grooves (e.g., one groove or a plurality of grooves) that provides the glass-based ribbon and/or ceramic-based ribbon with foldability at room temperature where the foldable substrate can comprise a foldable glass-based substrate (e.g., foldable glass substrate, foldable glass-ceramic substrate) and/or a foldable ceramic-based substrate (e.g., foldable ceramic substrate, foldable glass-ceramic substrate). Throughout the disclosure, a “glass-based ribbon”, “foldable glass-based ribbon”, “ceramic-based ribbon”, and/or “foldable ceramic-based ribbon” may also refer to a “foldable substrate” if the corresponding ribbon includes one or more grooves (e.g., one groove or a plurality of grooves) that provides it with foldability.

In some embodiments, as shown in FIGS. 9-11, the foldable substrate 803 can comprise a first major surface 903 and a second major surface 905 opposite the first major surface 903. As shown, the first major surface 903, excluding any grooves, can comprise a planar surface extending along a first plane 907. The second major surface 905 can comprise a planar surface extending along a second plane 909. In some embodiments, as shown, the second plane 909 can be substantially parallel to the first plane 907. In some embodiments, as shown, a substrate thickness 901 (T) can be defined between the first major surface 903 and the second major surface 905. In further embodiments, as shown, the substrate thickness 901 can be measured between the first plane 907 and the second plane 909. In some embodiments, the substrate thickness 901 may be substantially uniform across a length 805 of the foldable substrate 803 and/or a width 807 of the foldable substrate 803. In some embodiments, the foldable substrate 803 and/or the foldable apparatus 801, 1001, and 1101 can be foldable about a fold axis 811 extending in a direction 809 of the width 807 of the foldable substrate 803. As shown in FIG. 8, the width 807 of the foldable substrate 803 can extend in the direction 809 of the fold axis 811 of the foldable substrate 803 while the length 805 of the foldable substrate 803 can extend in a direction 813 perpendicular to the direction 809 of the fold axis 811. Throughout the disclosure, the width 807 of the foldable substrate 803 is considered the dimension of the foldable substrate 803 taken between opposed edges of the foldable substrate 803 in the direction 809 of the fold axis 811 of the foldable apparatus 801, 1001, and 1101. Furthermore, throughout the disclosure, the length 805 of the foldable substrate 803 is considered the dimension of the foldable substrate 803 taken between opposed edges of the foldable substrate 803 in the direction 813 perpendicular to the direction 809 of the fold axis 811 of the foldable apparatus 801, 1001, and 1101.

As shown in FIGS. 21-22, the foldable substrate 2103 can include a substrate thickness 2201 defined between a first major surface 2203 of the foldable substrate 2103 and a second major surface 2205 of the foldable substrate 2103 opposite the first major surface 2203. As shown in FIG. 22, in some embodiments, the first major surface 2203 can comprise a planar surface extending along a first plane 2207. In some embodiments, the second major surface 2205 can comprise a planar surface extending along a second plane 2209 that can be parallel to the first plane 2207. As shown in FIG. 22, the first major surface 2203 can be substantially parallel to the second major surface 2205, wherein the substrate thickness 2201 may be uniform across a length 2105 of the foldable substrate 2103 and a width 2107 of the foldable substrate 2103. As shown in FIG. 21, the width 2107 of the foldable substrate 2103 extends in a direction 2109 of a fold axis 2111 of the foldable substrate 2103 while the length 2105 of the foldable substrate 2103 extends in a direction 2113 perpendicular to the direction 2109 of the fold axis 2111.

In some embodiments, the substrate thickness 901 or 2201 of the foldable substrate 803 or 2103 can be sufficiently large to provide puncture resistance. For example, the substrate thickness 901 or 2201 can be about 80 micrometers (μm, microns) or more, about 100 μm or more, about 125 μm or more, about 200 μm or more, about 500 μm or more, about 3 millimeters (mm) or less, about 2 mm or less, about 1 mm or less, about 500 μm or less, or about 300 μm or less. In some embodiments, the substrate thickness 901 or 2201 can be in a range from about 80 μm to about 3 mm, from about 80 μm to about 2 mm, from about 80 μm to about 1 mm, from about 80 μm to about 500 μm, from about 100 μm to about 500 μm, from about 125 μm to about 500 μm, from about 200 μm to about 500 μm, from about 200 μm to about 300 μm, or any range or subrange therebetween. Throughout the disclosure, the thickness of the foldable substrate is considered the shortest distance between the first major surface (e.g., first plane) of the foldable substrate and the second major surface (e.g., second plane) of the foldable substrate at a location on the first major surface of the foldable substrate. For example, as shown in FIG. 9, in embodiments where the first major surface 903 is parallel to the second major surface 905 with each major surface 903, 905 comprising a respective planar major surface, the substrate thickness 901 extends in a thickness direction 902 that is perpendicular to the first major surface 903 at each location on the first major surface 903 along the length 805 and the width 807 of the foldable substrate 803. Likewise, as shown in FIG. 22, in embodiments where the first major surface 2203 is parallel to the second major surface 2205 with each major surface 2203, 2205 comprising a respective planar major surface, the substrate thickness 2201 extends in a thickness direction 2202 that is perpendicular to the first major surface 2203 at each location on the first major surface 2203 along the length 2105 and the width 2107 of the foldable substrate 2103.

In some embodiments, as shown in FIGS. 8-11, a plurality of grooves 815 (e.g., two or more grooves) can extend through the first major surface 903 of the foldable substrate 803. In some embodiments, as shown in FIGS. 8-11, a plurality of grooves 815 (e.g., two or more grooves) may be formed in the direction 809 of the fold axis 811. In some embodiments, as shown, a first groove of the plurality of grooves 815 can be substantially straight. In further embodiments, as shown, a second groove of the plurality of grooves 815 can be substantially parallel to the first groove of the plurality of grooves 815. In even further embodiments, all the grooves of the plurality of grooves 815 can be substantially parallel to one another.

As used herein, a central portion 820 of the foldable substrate 803 is defined as a region of the foldable substrate 803 between the outer edges of opposite end grooves of the plurality of grooves 815 as shown in FIG. 8. Consequently, the plurality of grooves 815 can be located in the central portion 820 of the foldable substrate 803. As used herein, a central width 819 of the central portion 820 is defined as a maximum distance in the direction 813 of the length 805 of the foldable substrate 803 between the outer edges of opposite end grooves that are positioned farthest away from one another in the direction 813. In some embodiments, the central width 819 can be about 0.5 mm or more, about 2 mm or more, about 10 mm or more, about 50 mm or less, about 30 mm or less, about 20 mm or less, or about 10 mm or less. In some embodiments, the central width 819 can be in a range from about 0.5 mm to about 50 mm, from about 2 mm to about 50 mm, from about 10 mm to about 30 mm, from about 10 mm to about 20 mm, from about 0.5 mm to about 10 mm, from about 2 mm to about 10 mm, or any range or subrange therebetween.

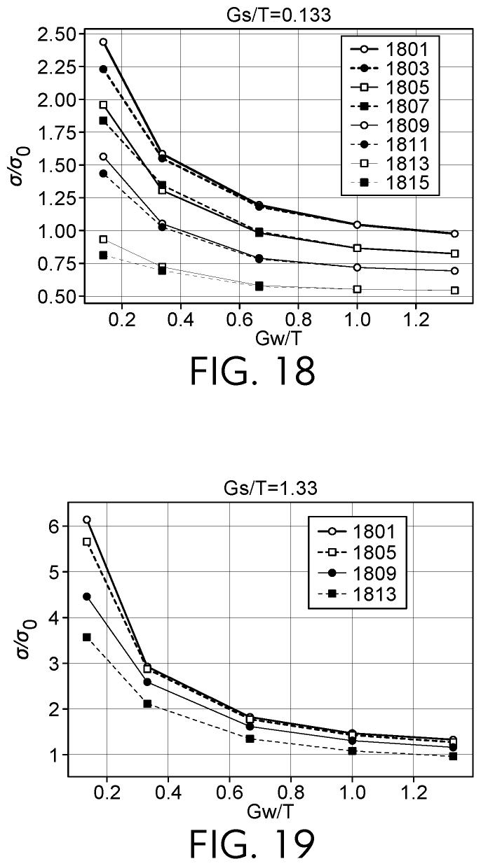

In some embodiments, as shown in FIGS. 8-9, a pair of adjacent grooves of the plurality of grooves 815 may be spaced apart from one another by a groove spacing 817 (Gs). As used herein, a groove spacing is defined as an average distance between the pair of adjacent grooves, wherein the distance at a predetermined location along the length of a groove is measured as the minimum distance between the corresponding adjacent groove surfaces at the location. In further embodiments, a ratio (Gs/T) of the groove spacing 817 (Gs) to the substrate thickness 901 (T) can be about 1.5 or less, which can provide for reduced bend-induced stress in the foldable substrate 803 comprising the plurality of grooves 815 in accordance with embodiments of the disclosure compared to a foldable substrate without grooves, as discussed below with regards to FIGS. 18-19. In further embodiments, a ratio (Gs/T) of the groove spacing 817 to the substrate thickness 901 can be about 0.1 or more, about 0.3 or more, about 0.5 or more, about 1.7 or less, about 1.5 or less, about 1.2 or less, about 1 or less. In further embodiments, a ratio (Gs/T) of the groove spacing 817 to the substrate thickness 901 can be in a range from about 0.1 to 1.7, from about 0.3 to about 1.7, from about 0.3 to about 1.5, from about 0.5 to about 1.5, from about 0.5 to about 1.2, from about 0.5 to about 1, or any range or subrange therebetween. In some embodiments, the groove spacing 817 can be in a range from about 1 mm to about 10 mm, from about 2 mm to about 10 mm, from about 2 mm to about 8 mm, from about 2 mm to about 5 mm, or any range or subrange therebetween. In some embodiments, the groove spacing 817 between each adjacent pair of grooves of the plurality of grooves can be substantially the same. In some embodiments, the groove spacing 817 between each adjacent pair of grooves 815 can be identical although different spacings may be provided between one or more pairs of adjacent grooves of the plurality of grooves 815 in further embodiments. As shown in FIG. 8, the central width 819 of the central portion 820 extends in the direction 813 of the length 805 of the foldable substrate 803 and can be from about 0.5 mm to about 5 mm. A plurality of grooves 815 may be provided between the opposite end grooves and may be comprise adjacent grooves that are spaced apart from one another by the groove spacing 817 (Gs).

As shown in FIG. 9, a groove of the plurality of grooves 815 comprises a groove surface 913. As used herein, a groove depth 911 (Gd) of a groove of the plurality of grooves 815 is defined as the maximum distance between the first plane 907 of the foldable substrate 803 and the groove surface 913 of the groove measured in the thickness direction 902 of the substrate thickness 901 of the foldable substrate 803. In some embodiments, the groove depth 911 is less than the substrate thickness 901, and the groove depth 911 of one or more grooves 815 (e.g., all grooves of the plurality of grooves 815) can be about 3 μm or more, about 10 μm or more, about 30 μm or more, about 90 μm or more, about 1.5 mm or less, about 1 mm or less, or about 0.5 mm or less. In some embodiments, the groove depth 911 is less than the substrate thickness 901, and the groove depth 911 of one or more grooves 815 (e.g., all grooves of the plurality of grooves 815) can be in a range from about 3 μm to about 1.5 mm, from about 10 μm to about 1.5 mm, from about 30 μm to about 1.5 mm, from about 30 μm to about 1 mm, from about 90 μm to about 1 mm, from about 90 μm to about 0.5 mm, or any range or subrange therebetween. In some embodiments, as shown, the groove depth 911 of each groove 815 along the length of each groove can be within a range from about 10 μm to about 95% of the substrate thickness 901 of the foldable substrate 803. In some embodiments, a ratio (Gd/T) of the groove depth 911 (Gd) to the substrate thickness 901 (T) of the foldable substrate 803 can be about 0.3 or more (e.g., from about 0.3 to about 0.95), which can provide for reduced bend-induced stress in a foldable substrate 803 comprising a plurality of grooves 815 in accordance with embodiments of the disclosure compared to a foldable substrate without grooves, as discussed below with regards to FIGS. 18-19. In some embodiments, a ratio (Gd/T) of the groove depth 911 to the substrate thickness 901 of the foldable substrate 803 can be about 0.1 or more, about 0.25 or more, about 0.3 or more, about 0.4 or more, about 0.6 or more, about 0.98 or less, about 0.95 or less, about 0.9 or less, or about 0.85 or less. In some embodiments, a ratio (Gd/T) of the groove depth 911 to the substrate thickness 901 of the foldable substrate 803 can be in a range from about 0.1 to about 0.98, from about 0.1 to about 0.95, from about 0.25 to about 0.95, from about 0.25 to about 0.9, from about 0.3 to about 0.9, from about 0.3 to about 0.85, from about 0.4 to about 0.85, from about 0.6 to about 0.85, or any range or subrange therebetween. In some embodiments, as shown in FIGS. 9-11, each groove of the plurality of grooves 815 can comprise substantially the same groove depth 911. In some embodiments, one or more grooves (e.g., all of the grooves) of the plurality of grooves 815 may include the ratio (Gd/T) within one or more of the ratios discussed above.

In some embodiments, a residual thickness 915 at each groove 815 of the plurality of grooves 815 can be defined as the minimum distance between the second major surface 905 (e.g., second plane 909) of the foldable substrate 803 and the groove surface 913 of the corresponding groove 815 measured in the thickness direction 902 of the substrate thickness 901 of the foldable substrate 803. In further embodiments, the residual thickness 915 can be about 30% or more (e.g., from about 30% to about 95%) of the substrate thickness 901 of the foldable substrate 803, which can provide for reduced bend-induced stress in a foldable substrate 803 comprising a plurality of grooves 815 in accordance with embodiments of the disclosure compared to a foldable substrate without grooves, as discussed below with regards to FIGS. 18-19. In further embodiments, the residual thickness 915 at one or more groove 815 (e.g., each groove 815 of the plurality of grooves 815) can be about 10 μm or more, about 20 μm or more, about 40 μm or more, about 60 μm or more, about 200 μm or less, about 100 μm or less, about 80 μm or less, or about 60 μm or less. In further embodiments, the residual thickness 915 at one or more groove 815 (e.g., each groove 815 of the plurality of grooves 815) can be in a range from about 10 μm to about 200 μm, from about 20 μm to about 200 μm, from about 20 μm to about 100 μm, from about 40 μm to about 100 μm, from about 40 μm to about 80 μm, from about 60 μm to about 80 μm, from about 10 μm to about 60 μm, from about 20 μm to about 60 μm, from about 40 μm to about 60 μm, or any range or subrange therebetween.

In some embodiments, as shown in FIG. 9, each groove of the plurality of grooves 815 can comprise a groove width 821 (Gw) measured in the direction 813 of the length 805 of the foldable substrate 803. In some embodiments, the groove width 821 may extend in the direction 813 perpendicular to the direction 809 of the fold axis 811 of the foldable substrate 803. In some embodiments, the groove width 821 of one or more grooves 815 (e.g., each groove of the plurality of grooves 815) can be about 10 μm or more, about 20 μm or more, about 40 μm or more, about 60 μm or more, about 600 μm or less, about 200 μm or less, about 100 μm or less, or about 80 μm or less. In some embodiments, the groove width 821 of one or more grooves 815 (e.g., each groove of the plurality of grooves 815) can be in a range from about 10 μm to about 600 μm, from about 20 μm to about 600 μm, from about 20 μm to about 200 μm, from about 40 μm to about 200 μm, from about 40 μm to about 100 μm, from about 60 μm to about 100 μm, from about 60 μm to about 80 μm, or any range or subrange therebetween. In some embodiments, the groove width 821 of each groove of the plurality of grooves 815 is identical although different groove widths 821 (e.g., within the range of 20 μm to about 200 μm) may be provided for different grooves in further embodiments. As shown, in some embodiments, the length of the groove 815 can extend as a continuous groove in the direction 809 of the fold axis 811 and perpendicular to the groove width 821 of the groove. As shown, the groove 815 can also extend across the entire width 807 of the foldable substrate 803. Although not shown, the groove 815 can extend discontinuously and/or the groove can extend across less than the entire width of the foldable substrate in further embodiments.

In some embodiments, a ratio (Gw/T) of the groove width 821 (Gw) of a groove of the plurality of grooves 815 to the substrate thickness 901 (T) of the foldable substrate 803 can be about 0.1 or more, which can provide for reduced bend-induced stress in a foldable substrate 803 comprising a plurality of grooves 815 in accordance with embodiments of the disclosure compared to a foldable substrate without grooves, as discussed below with regards to FIGS. 18-19. In some embodiments, a ratio (Gw/T) of the groove width 821 of a groove of the plurality of grooves 815 to the substrate thickness 901 of the foldable substrate 803 can be about 0.05 or more, about 0.1 or more, about 0.2 or more, about 0.4 or more, about 0.6 or more, about 5 or less, about 2 or less, or about 1 or less. In some embodiments, a ratio (Gw/T) of the groove width 821 of a groove of the plurality of grooves 815 to the substrate thickness 901 of the foldable substrate 803 can be in a range from about 0.05 to about 5, from about 0.1 to about 5, from about 0.1 to about 2, from about 0.2 to about 2, from about 0.2 to about 1, from about 0.4 to about 1, from about 0.6 to about 1, or any range or subrange therebetween. In some embodiments, a groove of the plurality of grooves 815 can comprise substantially the same groove width 821 along its length. In some embodiments, each groove of the plurality of grooves 815 can comprise substantially the same groove width 821. In some embodiments, one or more grooves (e.g., all of the grooves) of the plurality of grooves 815 may include the ratio (Gw/T) within one or more of the ratios discussed above.

In some embodiments, as shown in FIG. 8, a groove of the plurality of grooves 815 can comprise a groove length 823 measured in the direction 809 of the width 807 of the foldable substrate 803. In some embodiments, as shown, the groove length 823 can be substantially equal to the width 807 of the foldable substrate 803. In some embodiments, a ratio of the groove length 823 to the width 807 of the foldable substrate 803 can be about 0.05 or more, about 0.1 or more about 0.25 or more, 1 or less, about 0.9 or less, or about 0.75 or less. In some embodiments, a ratio of the groove length 823 to the width 807 of the foldable substrate 803 can be in a range from about 0.05 to 1, from about 0.1 to 1, from about 0.1 to about 0.9, from about 0.25 to about 0.9, from about 0.25 to about 0.75, or any range or subrange therebetween. In some embodiments, each groove of the plurality of grooves 815 can comprise substantially the same groove length 823.

In some embodiments, as shown in FIG. 9, a cross-sectional profile of a groove of the plurality of grooves 815 can comprise a curved surface. In further embodiments, as shown, groove surface 913 can comprise the curved surface. In further embodiments, the curved surface can comprise an elliptical curved surface. In further embodiments, the curved surface can comprise a circular curved surface. In further embodiments, as shown in FIG. 9 by dashed lines 917, the curved surface can comprise multiple curved segments. In even further embodiments, the curved surface can comprise a smooth surface. In some embodiments, a cross-sectional profile of a groove of the plurality of grooves 815 can comprise a smooth surface. In some embodiments, the groove surface 913 can comprise a smooth surface. As used herein, a smooth surface means a surface comprising a cross-sectional profile that can be approximated by a continuous curve including a continuous first derivative. In some embodiments, a cross-sectional profile of a groove of the plurality of grooves 815 can be substantially identical at ten (10) locations equidistantly spaced along the entire groove length. In further embodiments, the cross-sectional profile of the groove of the plurality of grooves 815 can be substantially identical at twenty (20) locations equidistantly spaced along the entire groove length. In even further embodiments, a cross-sectional profile of a groove of the plurality of grooves 815 can be substantially identical at all locations on the groove length. In some embodiments, each groove of the plurality of grooves 815 can comprise substantially the same cross-sectional profile.

In some embodiments, as shown in FIGS. 8-11, each groove of the plurality of grooves 815 can be substantially identical. In further embodiments, the plurality of grooves 815 can comprise substantially identical grooves. In further embodiments, each groove of the plurality of grooves 815 can comprise substantially the same groove length 823. In further embodiments, each groove of the plurality of grooves 815 can be substantially straight. In further embodiments, each groove of the plurality of grooves 815 can be substantially parallel to one another. In further embodiments, each groove of the plurality of grooves 815 can be substantially parallel to the fold axis 811. In further embodiments, each groove of the plurality of grooves 815 can comprise substantially the same groove width 821. In further embodiments, each groove of the plurality of grooves 815 can comprise substantially the same groove depth 911. In further embodiments, each groove of the plurality of grooves 815 can comprise substantially the same cross-sectional profile.

As shown, the cross-sectional opening segment comprises the segment at the opposing transitions of the first major surface 903 and the cross-sectional profile of the groove surface 913 that defines the groove width 821 of the groove 815. In some embodiments, as shown, the groove depth 911 of each groove 815 can comprise the same depth although different depths may be provided for different grooves in further embodiments. In some embodiments, as shown, the groove depth 911 of each groove 815 can be uniform across the length of the groove 815 although nonuniform depths may be provided in further embodiments. As shown, the groove surface 913 can have a cross-sectional profile taken perpendicular to the direction 809 of the fold axis 811 that is in the shape of an arc of a circle although other shapes may be provided in further embodiments. Furthermore, as indicated by dashed lines 917, the groove surface 913 may have a rounded transition to the first major surface 903 in some embodiments. Providing a uniform groove depth across the length of the groove can provide enhanced folding performance by reducing (e.g., minimizing, avoiding) stress concentrations at localized points of increased thickness and/or decreased thickness.

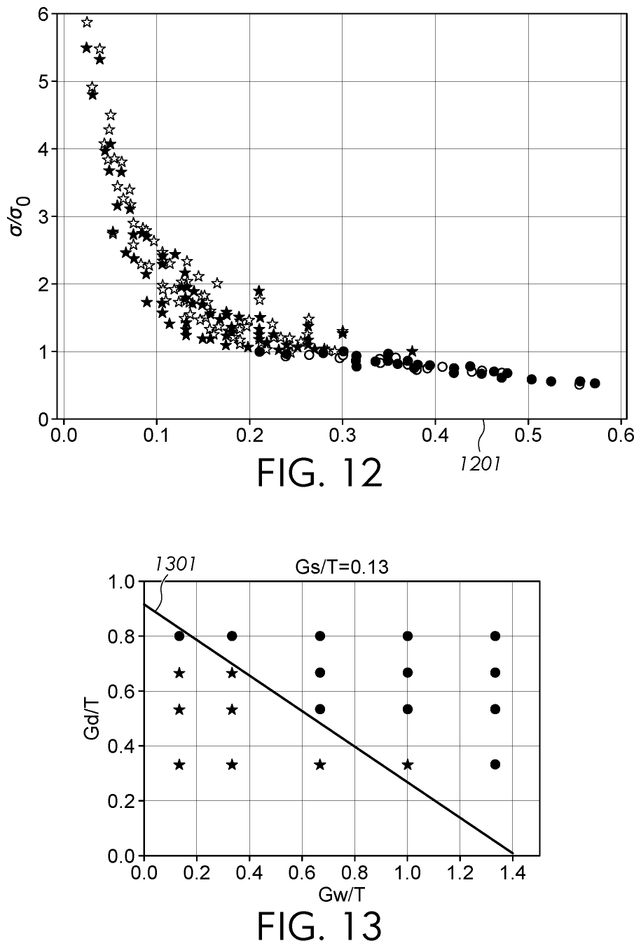

Throughout the disclosure, a combined groove volume (Vg) means a sum of a volume of each groove of the plurality of grooves 815 bounded by the first plane 907 and circumscribed by an outer periphery of the central portion 820. As used herein, a volume of a groove is defined as the volume between the groove surface 913, the first plane 907, and circumscribed by an outer periphery of the central portion 820. Throughout the disclosure, a central volume (Vc) means a volume defined between the first plane 907 and the second plane 909 and circumscribed by an outer periphery of the central portion 820. In some embodiments, a ratio (Vg/Vc) of the combined groove volume to the central volume can be about 0.3 or more, which can provide for reduced bend-induced stress in a foldable substrate 803 comprising a plurality of grooves 815 in accordance with embodiments of the disclosure compared to a foldable substrate without grooves, as discussed below with regards to FIG. 12. In some embodiments, a ratio (Vg/Vc) of the combined groove volume to the central volume can be about 0.25 or more, about 0.3 or more, about 0.4 or more, about 0.5 or more, about 0.75 or less, about 0.6 or less, or about 0.5 or less. In some embodiments, a ratio (Vg/Vc) of the combined groove volume to the central volume can be in a range from about 0.25 to about 0.75, from about 0.3 to about 0.75, from about 0.3 to about 0.6, from about 0.4 to about 0.6, from about 0.5 to about 0.6, from about 0.25 to about 0.5, from about 0.3 to about 0.5, from about 0.4 to about 0.5, or any range or subrange therebetween.

In some embodiments, foldable substrates 803 comprising a plurality of grooves 815 can satisfy the following relationship 7.93-6.19*(Gw/T) −9.52*(Gd/T) +6.05*(Gs/T) <0, where (Gw) is the groove width 821, (Gd) is the groove depth 911, (Gs) is the groove spacing 817, and (T) is the substrate thickness 901 of the foldable substrate 803. Providing foldable substrates 803 satisfying the above relationship can provide for reduced bend-induced stress in a foldable substrate 803 comprising a plurality of grooves 815 in accordance with embodiments of the disclosure compared to a foldable substrate without grooves, as discussed below with regards to FIGS. 13-17.

In alternative embodiments, as shown in FIGS. 21-24, a single groove 2115 may be formed in the glass-based ribbon along a width 2119 of a central portion 2120 to form the foldable substrate 2103 although multiple grooves may be provided in further embodiments. As shown in FIG. 21, the groove 2115 may be formed in the direction 2109 of the fold axis 2111 within the central portion 2120. As shown in FIGS. 21-22, a width 2119 of the central portion 2120 extends in the direction 2113 of the length 2105 of the foldable substrate 2103 and can be from about 4 mm to about 45 mm, from about 4 mm to about 40 mm, from about 4 mm to about 30 mm, from about 4 mm to about 20 mm, from about 4 mm to about 10 mm, from about 10 mm to about 45 mm, from about 10 mm to about 40 mm, from about 10 mm to about 30 mm, from about 10 mm to about 20 mm, from about 20 mm to about 45 mm, from about 20 mm to about 40 mm, from about 20 mm to about 30 mm, from about 30 mm to about 45 mm, from about 30 mm to about 40 mm, from about 40 mm to about 45 mm, or any range of subrange therebetween.

As shown in FIGS. 21-22, in some embodiments, the central portion 2120 can optionally include a first transition portion 2211 extending a distance 2213 between a central region 2216 and a first portion 2215 in the direction 2113 of the length 2105 of the foldable substrate 2103. In some embodiments, the central portion 2120 can optionally include a second transition portion 2217 extending a distance 2219 between the central region 2216 and a second portion 2221 in the direction 2113 of the length 2105 of the foldable substrate 2103. In some embodiments, the distance 2213 of the first transition portion 2211 and/or the distance 2219 of the second transition portion 2217 can be about 1 mm or more, about 2 mm or more, about 3 mm or more, about 5 mm or less, about 4 mm or less, or about 3 mm or less. In some embodiments, the distance 2213 of the first transition portion 2211 and/or the distance 2219 of the second transition portion 2217 can be in a range from about 1 mm to about 5 mm, from about 1 mm to about 4 mm, from about 2 mm to about 4 mm, from about 2 mm to about 3 mm, from about 3 mm to about 4 mm, or any range or subrange therebetween.

As shown in FIG. 22, a groove depth 2222 of the groove 2115 is defined as the maximum distance between the first plane 2207 (e.g., the cross-sectional opening 2125 into the cross-sectional opening 2125) and the groove surface 2223 of the groove 2115 measured in the thickness direction 2202 of the substrate thickness 2201 (taken perpendicular to the direction 2109 of the fold axis 2111). As shown, the cross-sectional opening 2125 comprises a portion of the first plane 2207 between the first major surface 2203 in the first portion 2215 and the second portion 2221. In some embodiments, the cross-sectional opening 2125 extends for a combined distance of the width 2119 and any distances 2213, 2219 of opposing transitions of the first major surface 2203 and the cross-sectional profile of the groove surface 2223 (e.g., the groove surface 2223 of the transition portions 2211, 2217 if provided). In some embodiments, as shown, the groove depth 2222 of each groove 2115 can comprise the same depth although different depths may be provided for different grooves in further embodiments. In some embodiments, as shown, the groove depth 2222 of each groove 2115 can be uniform across the length of the groove 2115 although nonuniform depths may be provided in further embodiments. The groove depth 2222 of each groove 2115 can be less than the substrate thickness 2201. In some embodiments, as shown, the groove depth 2222 of each groove 2115 along the length of each groove can be within a range from about 10 μm to about 95% of the substrate thickness 2201 of the foldable substrate 2103. In some embodiments, the groove depth 2222 of each groove 2115 can be within a range of about 70 μm to 1.8 mm, from about 70 μm to about 900 μm, from about 70 μm to about 400 μm, from about 70 μm to about 200 μm, from about 190 μm to about 1.8 mm, from about 190 μm to about 900 μm, from about 190 μm to about 400 μm, from about 400 μm to about 1.8 mm, from about 400 μm to about 900 μm, or any range or subrange therebetween. In some embodiments, the groove depth 2222 at the central region 2216 of the groove 2115 can be substantially uniform along the width 2119 of the central region 2216 and the length of the central region 2216 extending in the direction 2109 of the fold axis 2111 although nonuniform groove depths 2222 may be provided in further embodiments. Providing a uniform groove depth 2222 can allow a beneficial thickness to be employed over a larger area of the central portion 2120, whereby there may be attained good puncture resistance and a good effective minimum bend radius. Providing a uniform groove depth across the length of the groove can provide enhanced folding performance by reducing (e.g., minimizing, avoiding) stress concentrations at localized points of increased thickness and/or decreased thickness.

In some embodiments, the foldable substrate 803 and/or 2103 can comprise a glass-based ribbon and/or a ceramic-based ribbon, as described above. In further embodiments, the foldable substrate 803 can comprise a compressive stress region. In even further embodiments, the compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the foldable substrate 803 can enable small (e.g., smaller, about 10 mm or less) bend radii because the compressive stress from the chemical strengthening can counteract the bend-induced tensile stress on the outermost surface of the substrate (e.g., first major surface 903, second major surface 905). A compressive stress region may extend into a portion of the substrate for a depth called the depth of compression.

As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the substrate, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

In some embodiments, the foldable substrate 803 may be chemically strengthened to produce one or more compressive stress regions. In some embodiments, the foldable substrate 803 may comprise a first compressive stress region extending to a first depth of compression from the first major surface 903. In some embodiments, the foldable substrate 803 may comprise a second compressive stress region extending to a second depth of compression from the second major surface 905. In even further embodiments, the first depth of compression and/or the second depth of compression as a percentage of the substrate thickness 901 can be about 10% or more, about 15% or more, about 20% or more, about 30% or less, about 25% or less, or about 20% or less. In even further embodiments, the first depth of compression and/or the second depth of compression as a percentage of the substrate thickness 901 can be in a range from about 10% to about 30%, from about 10% to about 25%, from about 15% to about 25%, from about 15% to about 20%, or any range or subrange therebetween. In still further embodiments, the first depth of compression from the first major surface 903 may be substantially equal to the second depth of compression from the second major surface 905.

In some embodiments, the first compressive stress region can comprise a first maximum compressive stress. In some embodiments, the second compressive stress region can comprise a second maximum compressive stress. In further embodiments, the first maximum compressive stress and/or the second maximum compressive stress can be about 100 MegaPascals (MPa) or more, about 200 MPa or more, about 300 MPa or more, about 400 MPa or more, about 500 MPa or more, about 600 MPa or more, about 700 MPa or more, about 1,500 MPa or less, about 1,200 MPa or less, about 1,000 MPa or less, about 600 MPa or less, or about 400 MPa or less. In further embodiments, the first maximum compressive stress and/or the second maximum compressive stress can be in a range from about 100 MPa to about 1,500 MPa, from about 200 MPa to about 1,500 MPa, from about 200 MPa to about 1,200 MPa, from about 300 MPa to about 1,200 MPa, from about 300 MPa to about 1,000 MPa, from about 300 MPa to about 600 MPa, from about 300 MPa to about 400 MPa, 700 MPa to about 1,500 MPa, from about 700 MPa to about 1,200 MPa, from about 700 MPa to about 1,000 MPa, from about 700 MPa to about 900 MPa, or any range or subrange therebetween. Providing a first maximum compressive stress and/or a second maximum compressive stress in a range from about 100 MPa to about 1,500 MPa can enable good impact and/or puncture resistance.

In some embodiments, the second major surface 905 of the foldable substrate 803 can comprise an optional coating. In some embodiments, the coating, if provided, may comprise one or more of an easy-to-clean coating, a low-friction coating, an oleophobic coating, a diamond-like coating, a scratch-resistant coating, or an abrasion-resistant coating. A scratch-resistant coating may comprise an oxynitride, for example, aluminum oxynitride or silicon oxynitride with a thickness of about 500 μm or more. In such embodiments, the abrasion-resistant layer may comprise the same material as the scratch-resistant layer. In some embodiments, a low friction coating may comprise a highly fluorinated silane coupling agent, for example, an alkyl fluorosilane with oxymethyl groups pendant on the silicon atom. In such embodiments, an easy-to-clean coating may comprise the same material as the low friction coating. In other embodiments, the easy-to-clean coating may comprise a protonatable group, for example, an amine, for example, an alkyl aminosilane with oxymethyl groups pendant on the silicon atom. In such embodiments, the oleophobic coating may comprise the same material as the easy-to-clean coating. In some embodiments, a diamond-like coating comprises carbon and may be created by applying a high voltage potential in the presence of a hydrocarbon plasma.

In some embodiments, an optically transparent polymeric hard-coat layer can be disposed over or bonded to the second major surface 905 of the foldable substrate 803. Suitable materials for an optically transparent polymeric hard-coat layer include, but are not limited to: a cured acrylate resin material, an inorganic-organic hybrid polymeric material, an aliphatic or aromatic hexafunctional urethane acrylate, a siloxane-based hybrid material, and a nanocomposite material, for example, an epoxy and urethane material with nanosilicate. In some embodiments, an optically transparent polymeric hard-coat layer may consist essentially of one or more of these materials. In some embodiments, an optically transparent polymeric hard-coat layer may consist of one or more of these materials. As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. More specifically, suitable materials for an optically transparent polymeric (OTP) hard-coat layer include, but are not limited to, a polyimide, a polyethylene terephthalate (PET), a polycarbonate (PC), a poly methyl methacrylate (PMMA), organic polymer materials, inorganic-organic hybrid polymeric materials, and aliphatic or aromatic hexafunctional urethane acrylates. In some embodiments, an OTP hard-coat layer may consist essentially of an organic polymer material, an inorganic-organic hybrid polymeric material, or aliphatic or aromatic hexafunctional urethane acrylate. In some embodiments, an OTP hard-coat layer may consist of a polyimide, an organic polymer material, an inorganic-organic hybrid polymeric material, or aliphatic or aromatic hexafunctional urethane acrylate. In some embodiments, an OTP hard-coat layer may include a nanocomposite material. In some embodiments, an OTP hard-coat layer may include a nano-silicate at least one of epoxy and urethane materials. Suitable compositions for such an OTP hard-coat layer are described in U.S. Pat. Pub. No. 2015/0110990, which is hereby incorporated by reference in its entirety by reference thereto. As used herein, “organic polymer material” means a polymeric material comprising monomers with only organic components. In some embodiments, an OTP hard-coat layer may comprise an organic polymer material manufactured by Gunze Limited and having a hardness of 9H, for example, Gunze's “Highly Durable Transparent Film.” As used herein, “inorganic-organic hybrid polymeric material” means a polymeric material comprising monomers with inorganic and organic components. An inorganic-organic hybrid polymer is obtained by a polymerization reaction between monomers having an inorganic group and an organic group. An inorganic-organic hybrid polymer is not a nanocomposite material comprising separate inorganic and organic constituents or phases, for example, inorganic particulates dispersed within an organic matrix. In some embodiments, the inorganic-organic hybrid polymeric material may include polymerized monomers comprising an inorganic silicon-based group, for example, a silsesquioxane polymer. A silsesquioxane polymer may be, for example, an alky-silsesquioxane, an aryl-silsesquioxane, or an aryl alkyl-silsesquioxane having the following chemical structure: (RSiO_{1.5})n, where R is an organic group for example, but not limited to, methyl or phenyl. In some embodiments, an OTP hard-coat layer may comprise a silsesquioxane polymer combined with an organic matrix, for example, SILPLUS manufactured by Nippon Steel Chemical Co., Ltd. In some embodiments, an OTP hard-coat layer may comprise 90 wt % to 95 wt % aromatic hexafunctional urethane acrylate (e.g., PU662NT (aromatic hexafunctional urethane acrylate) manufactured by Miwon Specialty Chemical Co.) and 10 wt % to 5 wt % photo-initiator (e.g., Darocur 1173 manufactured by Ciba Specialty Chemicals Corporation) with a hardness of 8H or more. In some embodiments, an OTP hard-coat layer composed of an aliphatic or aromatic hexafunctional urethane acrylate may be formed as a stand-alone layer by spin-coating the layer on a polyethylene terephthalate (PET) substrate, curing the urethane acrylate, and removing the urethane acrylate layer from the PET substrate. An OTP hard-coat layer may have a thickness in a range of 1 μm to 150 μm, for example from 10 μm to 140 μm, from 20 μm to 130 30 μm to 120 from 40 μm to 110 μm, from 50 μm to 100 μm, from 60 μm to 90 μm, 70 μm, 80 μm, 2 μm to 140 μm, from 4 μm to 130 μm, 6 μm to 120 μm, from 8 μm to 110 μm, from 10 μm to 100 μm, from 10 μm to 90 μm, 10 μm, 80 μm, 10 μm, 70 μm, 10 μm, 60 μm, 10 μm, 50 μm, or within a range having any two of these values as endpoints. In some embodiments, an OTP hard-coat layer may be a single monolithic layer. In some embodiments, an OTP hard-coat layer may be an inorganic-organic hybrid polymeric material layer or an organic polymer material layer having a thickness in the range of 80 μm to 120 μm, including subranges. For example, an OTP hard-coat layer comprising an inorganic-organic hybrid polymeric material or an organic polymer material may have a thickness of from 80 μm to 110 μm, 90 μm to 100 μm, or within a range having any two of these values as endpoints. In some embodiments, an OTP hard-coat layer may be an aliphatic or aromatic hexafunctional urethane acrylate material layer having a thickness in the range of 10 μm to 60 μm, including subranges. For example, an OTP hard-coat layer comprising an aliphatic or aromatic hexafunctional urethane acrylate material may have a thickness of 10 μm to 55 μm, 10 μm to 50 μm, 10 μm to 40 μm, 10 μm to 45 μm, 10 μm to 40 μm, 10 μm to 35 μm, 10 μm to 30 μm, 10 μm to 25 μm, 10 μm to 20 μm, or within a range having any two of these values as endpoints.

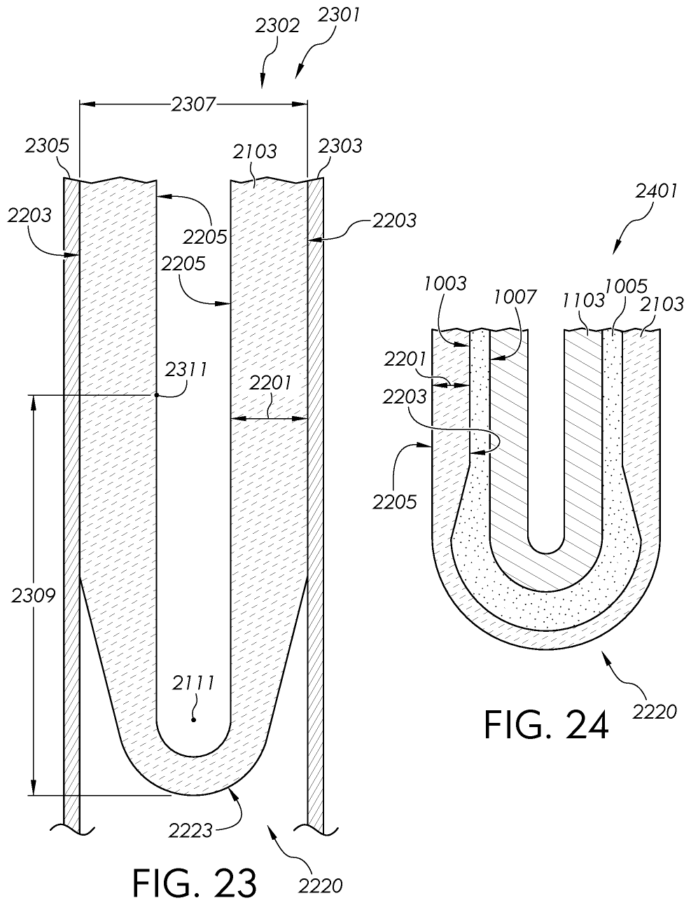

The foldable apparatus may have a failure mode that can be described as a low energy failure or a high energy failure. The failure mode of the foldable apparatus can be measured using the impact apparatus 2301 shown in FIG. 23. The impact apparatus 2301 is similar to the parallel plate apparatus in FIG. 11 (described below). However, the foldable substrate 803 or 2103 is tested in the impact apparatus 2301 without an adhesive (e.g., optically clear adhesive 1005), release liner 1009, and/or display device 1103 disposed over the foldable substrate 803 or 2103. In FIG. 23, the foldable apparatus 2302 comprising the foldable substrate 2103 without an adhesive, release liner, and/or display device disposed over the foldable substrate 2103 is tested. As shown in FIG. 23, the first major surface 2203 of the foldable substrate 2103 is attached to the parallel plates 2303, 2305. The parallel plates 2303, 2305 are moved together at a rate of 5 mm/second until the target parallel plate distance 2307 is achieved. The target parallel plate distance 2307 is the larger of 4 mm or twice the effective minimum bend radius of the foldable substrate 2103. Then, a tungsten carbide sharp contact probe impinges on the foldable substrate 2103 at an impact location 2311 that is a predetermined distance 2309 from the outermost periphery of the groove surface 2223 of the central portion 2120 of the foldable substrate 2103. The predetermined distance 2309 is 30 mm. As used herein, a fracture is high energy if an average speed of particles ejected from the foldable substrate during fracture is 1 meter per second (m/s) or more and the fracture results in more than 2 crack branches. As used herein, a fracture is low energy if the fracture results in 2 or less crack branches and/or does not result in an average velocity of particles ejected from the foldable substrate during fracture of 1 m/s or more. The average velocity of ejected particles may be measured by capturing high-speed video of the foldable substrate 2103 from when the sharp contact probe contacts the impact location 2311 to 5,000 microseconds afterward.

Providing a foldable substrate with low energy failure (e.g., low fracture energy, low energy fracture) can avoid particles with an average speed in excess of 1 m/s on failure. In some embodiments, low energy fractures may be the result of the reduced thickness of the central portion, which stores less energy for a given maximum tensile stress than a thicker portion (e.g., glass-based portion) would. In some embodiments, low energy fractures may be the result of fractures in the first portion and/or second portion located away from the central portion undergoing the bend, where the first portion and/or second portion comprise lower maximum tensile stresses than the central portion.

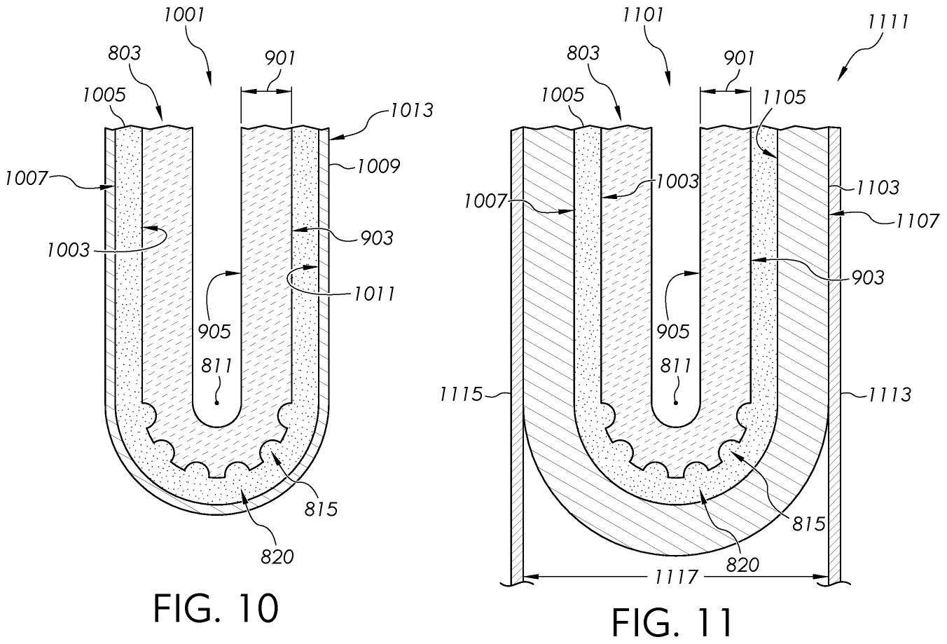

As shown in FIGS. 10-11 and 24, the foldable apparatus 1001, 1101, and 2401 can comprise an optically clear adhesive 1005. The optically clear adhesive 1005 can comprise a first contact surface 1003. In some embodiments, as shown, the optically clear adhesive 1005 can be disposed over the first major surface 903 or 1303 of the foldable substrate 803 or 2103. In further embodiments, as shown, the first contact surface 1003 of the optically clear adhesive 1005 can contact the first major surface 903 or 1303 of the foldable substrate 803 or 2103, and the optically clear adhesive 1005 can be bonded to the first major surface 903 or 1303. In some embodiments, as shown, the first contact surface 1003 of the optically clear adhesive 1005 can be disposed over the central portion 820 or 2120 of the first major surface 903 or 1303 of the foldable substrate 803 or 2103. In further embodiments, as shown, the first contact surface 1003 of the optically clear adhesive 1005 can contact the central portion 820 or 2120 of the foldable substrate 803, and the optically clear adhesive 1005 can be bonded to the central portion 820 or 2120. As shown in FIGS. 10-11, the optically clear adhesive 1005 can fill a recess defined between the first plane 907 and the groove surface 913 of a groove of the plurality of grooves 815. As shown in FIG. 24 the optically clear adhesive 1005 can fill a recess defined between the first plane 2207 and the groove surface 2223 of the groove 2115. In some embodiments, although not shown, the recess may not be totally filled, for example, to leave room for electronic devices and/or mechanical devices.

As used herein, if a first layer and/or component is described as “disposed over” a second layer and/or component, other layers may or may not be present between the first layer and/or component and the second layer and/or component. As used herein, if a first layer and/or component described as “bonded to” a second layer and/or component means that the layers and/or components are bonded to each other, either by direct contact and/or bonding between the two layers and/or components or via an adhesive layer.

The optically clear adhesive 1005 can comprise a second contact surface 1007 that can be opposite the first contact surface 1003 and spaced from the first contact surface 1003. In some embodiments, as shown in FIGS. 10-11, the second contact surface 1007 of the optically clear adhesive 1005 can comprise a planar surface. In further embodiments, as shown, the planar surface of the second contact surface 1007 of the optically clear adhesive 1005 can be parallel to the first plane 907.

As used herein, “optically transparent” means an average transmittance of 70% or more in the wavelength range of 400 nm to 700 nm through a 1.0 mm thick piece of a material. In some embodiments, an optically transparent material may have an average transmittance of 75% or more, 80% or more, 85% or more, or 90% or more, 92% or more, 94% or more, 96% or more in the wavelength range of 400 nm to 700 nm through a 1.0 mm thick piece of the material. The average transmittance in the wavelength range of 400 nm to 700 nm is calculated by measuring the transmittance of whole number wavelengths from about 400 nm to about 700 nm and averaging the measurements. In some embodiments, the foldable substrate 803 can be optically transparent.

The optically clear adhesive 1005 can comprise a first index of refraction. The first refractive index may be a function of a wavelength of light passing through the optically clear adhesive 1005. For light of a first wavelength, a refractive index of a material is defined as the ratio between the speed of light in a vacuum and the speed of light in the corresponding material. Without wishing to be bound by theory, a refractive index of the optically clear adhesive 1005 can be determined using a ratio of a sine of a first angle to a sine of a second angle, where light of the first wavelength is incident from air on a surface of the optically clear adhesive 1005 at the first angle and refracts at the surface of the optically clear adhesive 1005 to propagate light within the optically clear adhesive 1005 at a second angle. The first angle and the second angle are both measured relative to a normal of a surface of the optically clear adhesive 1005. As used herein, the refractive index is measured in accordance with ASTM E1967-19, where the first wavelength comprises 589 nm. In some embodiments, the first refractive index of the optically clear adhesive 1005 may be about 1 or more, about 1.3 or more, about 1.4 or more, about 1.45 or more, about 3 or less, about 2 or less, about 1.7 or less, about 1.6 or less, or about 1.55 or less. In some embodiments, the first refractive index of the optically clear adhesive can be in a range from about 1 to about 3, from about 1 to about 2 from about 1.3 to about 2, from about 1.3 to about 1.7, from about 1.4 to about 1.7, from about 1.4 to about 1.6, from about 1.45 to about 1.6, from about 1.45 to about 1.55, or any range or subrange therebetween.

The foldable substrate 803 can be optically transparent and can comprise a second index of refraction. The second index of refraction can be within any of the ranges for the first index of refraction discussed above. A differential equal to the absolute value of the difference between the second index of refraction of the foldable substrate 803 and the first index of refraction of the optically clear adhesive 1005 can be about 0.1 or less, about 0.07 or less, about 0.05 or less, about 0.001 or more, about 0.01 or more, or about 0.02 or more. In some embodiments, the differential is in a range from about 0.001 to about 0.1, from about 0.001 to about 0.07, from about 0.01 to about 0.07, from about 0.01 to about 0.05, from about 0.02 to about 0.05, or any range or subrange therebetween. In some embodiments, the second index of refraction of the foldable substrate 803 may be greater than the first index of refraction of the optically clear adhesive 1005. In some embodiments, the second index of refraction of the foldable substrate 803 may be less than the first index of refraction of the optically clear adhesive 1005.

Suitable optically clear adhesives 1005 can comprise, but are not limited to, acrylic adhesives, for example, 3M 8212 adhesive, or an optically transparent liquid adhesive, for example, a LOCTITE optically transparent liquid adhesive. Exemplary embodiments of optically clear adhesives 1005 comprise transparent acrylics, epoxies, silicones, and polyurethanes. A thickness of the optically clear adhesive 1005 measured from the first contact surface 1003 of the optically clear adhesive 1005 the second contact surface 1007 of the optically clear adhesive 1005 can be about 1 μm or more, about 5 μm or more, about 10 μm or more, about 20 μm or more, about 100 μm or less, about 50 μm or less, or about 30 μm or less. In some embodiments, the thickness of the optically clear adhesive 1005 can be in a range from about 1 μm to about 100 μm, from about 5 μm to about 100 μm, from about 5 μm to about 50 μm, from about 10 μm to about 50 μm, from about 10 μm to about 30 μm, from about 20 μm to about 30 μm, or any range or subrange therebetween.

In some embodiments, as shown in FIG. 10, the foldable apparatus 1001 can comprise a release liner 1009. In further embodiments, as shown, the release liner 1009 can be disposed over the optically clear adhesive 1005. In even further embodiments, as shown, the release liner 1009 can directly contact (e.g., be bonded to) the second contact surface 1007 of the optically clear adhesive 1005. The release liner 1009 can comprise a first major surface 1013 and a second major surface 1011 opposite the first major surface 1013. As shown, the release liner 1009 can be deposited on the optically clear adhesive 1005 by attaching the second contact surface 1007 of the optically clear adhesive 1005 to the second major surface 1011 of the release liner 1009. In some embodiments, as shown, the first major surface 1013 of the release liner 1009 can comprise a planar surface. In some embodiments, as shown, the second major surface 1011 of the release liner 1009 can comprise a planar surface. The release liner 1009 can comprise a paper and/or a polymer. Exemplary embodiments of paper comprise kraft paper, machine-finished paper, polycoated paper (e.g., polymer-coated, glassine paper, siliconized paper), or clay-coated paper. Exemplary embodiments of polymers comprise polyesters (e.g., polyethylene terephthalate (PET)) and polyolefins (e.g., low-density polyethylene (LDPE), high-density polyethylene (HDPE), polypropylene (PP)).

In some embodiments, as shown in FIGS. 11 and 24, the foldable apparatus 1101 or 2401 can comprise a display device 1103. In further embodiments, as shown, the display device 1103 can be disposed over the optically clear adhesive 1005. In further embodiments, as shown, the display device 1103 can direct contact (e.g., be bonded to) to the second contact surface 1007 of the optically clear adhesive 1005. In some embodiments, producing the foldable apparatus 1101 or 2401 may be achieved by removing the release liner 1009 of the foldable apparatus 1001 of FIG. 10 and attaching the display device 1103 to the second contact surface 1007 of the optically clear adhesive 1005. Alternatively, the foldable apparatus 1101 or 2401 may be produced without the extra step of removing a release liner 1009 before attaching the display device 1103 to the second contact surface 1007 of the optically clear adhesive 1005, for example, when a release liner 1009 is not applied to the second contact surface 1007 of the optically clear adhesive 1005. The display device 1103 can comprise a first major surface 1107 and a second major surface 1105 opposite the first major surface 1107. As shown, the display device 1103 can be deposited on the optically clear adhesive 1005 by attaching the second contact surface 1007 of the optically clear adhesive 1005 to the second major surface 1105 of the display device 1103. In some embodiments, as shown, the first major surface 1107 of the display device 1103 can comprise a planar surface. In some embodiments, as shown, the second major surface 1105 of the display device 1103 can comprise a planar surface. The display device 1103 can comprise liquid crystal display (LCD), an electrophoretic displays (EPD), an organic light emitting diode (OLED) display, or a plasma display panel (PDP). In some embodiments, the display device 1103 can be part of a portable electronic device, for example, a consumer electronic product, a smartphone, a tablet, a wearable device, or a laptop.

Embodiments of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In some embodiments, at least one of a portion of the housing or the cover substrate comprises the foldable apparatus made by methods discussed throughout the disclosure.

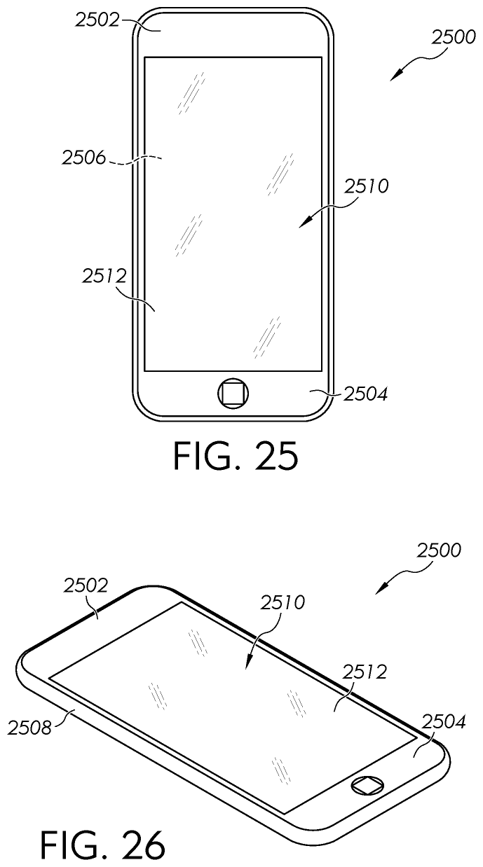

The foldable apparatus disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the foldable apparatus disclosed herein is shown in FIGS. 25-26. Specifically, FIGS. 25-26 show a consumer electronic device 2500 including a housing 2502 having front 2504, back 2506, and side surfaces 2508; electrical components (not shown) that are at least partially inside or entirely within the housing and including at least a controller, a memory, and a display 2510 at or adjacent to the front surface of the housing; and a cover substrate 2512 at or over the front surface of the housing such that it is over the display. In some embodiments, at least one of the cover substrate 2512 or a portion of housing 2502 may include any of the foldable apparatus disclosed herein, for example, the foldable substrate.

In some embodiments, the foldable apparatus can be folded about the fold axis 811 to form a folded configuration (e.g., see FIGS. 10-11). As shown, the foldable apparatus may include a single fold axis to allow the foldable apparatus to comprise a bifold wherein, for example, the foldable apparatus may be folded in half. In further embodiments, the foldable apparatus may include two or more fold axes with each fold axis including a corresponding central portion similar or identical to the central portion 820 discussed above. For example, providing two fold axes can allow the foldable apparatus to comprise a trifold.

As shown in FIGS. 10-11 the foldable apparatus is folded such that the display device 1103 is on the outside of the folded foldable apparatus 1101 while the second major surface 905 of the foldable substrate 803 is on the inside of the folded foldable apparatus. As configured, a user would view the display device through the substrate and, thus, would be positioned on the side of the second major surface 905. Although not shown, in further embodiments, the foldable apparatus may fold in an opposite manner such that the second major surface 905 is on the outside and the display device 1103 is on the inside of the folded foldable apparatus. In further embodiments, although not shown, the foldable apparatus may be assembled such that the display device 1103 is disposed over the second major surface 905 of the foldable substrate 803 whereby the user would view the display device 1103 from the first major surface 903 of the foldable substrate 803. When the display device 1103 is disposed over the second major surface 905, the foldable apparatus may be folded either in a direction so that the second major surface 905 faces itself or in a direction so that the first major surface 903 faces itself.

As used herein, “foldable” includes complete folding, partial folding, bending, flexing, or multiple capabilities. As used herein, the terms “fail,” “failure” and the like refer to breakage, destruction, delamination, or crack propagation. A foldable substrate and/or foldable apparatus achieves an effective bend radius of “X,” or has an effective bend radius of “X,” or comprises an effective bend radius of “X” if it resists failure when the foldable substrate and/or foldable apparatus is held at “X” radius for 24 hours at about 85° C. and about 85% relative humidity.

As used herein, the “effective minimum bend radius” of a foldable substrate (e.g., foldable substrate 803, foldable substrate 2103) is measured with the following test configuration and process using a parallel plate apparatus 1111 (see FIG. 11) that comprises a pair of parallel rigid stainless-steel plates 1113, 1115 comprising a first rigid stainless-steel plate 1113 and a second rigid stainless-steel plate 1115. When measuring the “effective minimum bend radius”, the optically clear adhesive 1005 comprises a thickness of 50 μm between the second contact surface 1007 of the optically clear adhesive 1005 and the first major surface 903 of the foldable substrate 803 or 2203. When measuring the “effective minimum bend radius”, the test is conducted with a 100 μm thick sheet of polyethylene terephthalate (PET) rather than the display device 1103 shown in FIG. 11. Thus, during the test to determine the “effective minimum bend radius”, the display device 1103 is not used. Rather than the display device 1103, the 100 μm thick sheet of polyethylene terephthalate (PET) is attached to the second contact surface 1007 of the optically clear adhesive 1005 in an identical manner that the release liner 1009 or display device 1103 is attached to the second contact surface 1007 as shown in FIG. 10. For the foldable apparatus 1001 shown in FIG. 10, the release liner 1009 is replaced with the 100 μm thick sheet of PET attached to the second contact surface 1007 of the optically clear adhesive 1005. For the foldable apparatus 2401 shown in FIG. 24, the display device 1103 is replaced with the 100 μm thick sheet of PET attached to the second contact surface of the optically clear adhesive 1005. For the foldable apparatus 801 shown in FIGS. 8-9, the 50 μm thick optically clear adhesive 1005 is attached to the first major surface 903 of the foldable substrate 803, and 100 μm thick sheet of PET is attached to the 50 μm thick optically clear adhesive 1005. For the foldable apparatus 2302 shown in FIG. 23, the 50 μm thick optically clear adhesive 1005 is attached to the first major surface 2203 of the foldable substrate 803, and 100 μm thick sheet of PET is attached to the 50 μm thick optically clear adhesive 1005. The assembled foldable substrate 803, 50 μm thick optically clear adhesive 1005, and 100 μm thick sheet of PET is placed between the pair of parallel rigid stainless-steel plates 1113, 1115 such that the foldable substrate 803 will be on the inside of the bend, similar to the configuration shown in FIG. 11. The distance between the parallel plates is reduced at a rate of 50 μm/second until the parallel plate distance 1117 is equal to twice the “effective minimum bend radius” to be tested. Then, the parallel plates are held at twice the effective minimum bend radius to be tested for 24 hours at about 85° C. and about 85% relative humidity. As used herein, the “effective minimum bend radius” is the smallest effective bend radius that the foldable substrate 803 can withstand without failure under the conditions and configuration described above.

In some embodiments, the foldable substrate 803 of the foldable apparatus 801, 1001, or 1101 can achieve an effective bend radius of 20 mm, 10 mm, or 7 mm, or 5 mm, or 1 mm. In some embodiments, the foldable substrate 803 of the foldable apparatus 801, 1001, or 1101 can comprise an effective minimum bend radius of about 20 mm or less, 10 mm or less, about 7 mm or less, about 5 mm or less, about 1 mm or more, about 2 mm or more, or about 5 mm or more. In some embodiments, the foldable substrate 803 of the foldable apparatus 801, 1001, or 1101 can comprise an effective minimum bend radius in a range from about 1 mm to about 10 mm, from about 1 mm to about 7 mm, from about 2 mm to about 7 mm, from about 2 mm to about 5 mm, from about 5 mm to about 10 mm, from about 5 mm to about 7 mm, or any range or subrange therebetween.

In some embodiments, the central width 819 can be about 3 times the effective minimum bend radius or more. Without wishing to be bound by theory, the length of a bent portion in a circular configuration between parallel plates can be about 1.6 times the parallel plate distance 1117 (e.g., about 3 times the effective minimum bend radius, about 3.2 times the effective minimum bend radius). In some embodiments, the central width 819 of the central portion 820 of the foldable substrate 803 can be about 4.4 times the effective minimum bend radius or more. Without wishing to be bound by theory, the length of a bent portion in an elliptical configuration between parallel plates can be about 2.2 times the parallel plate distance 1117 (e.g., about 4.4 times the effective minimum bend radius). In some embodiments, the central width 819 of the central portion 820 of the foldable substrate 803 can be substantially equal to or greater than the bend length of the foldable substrate at its effective minimum bend radius.

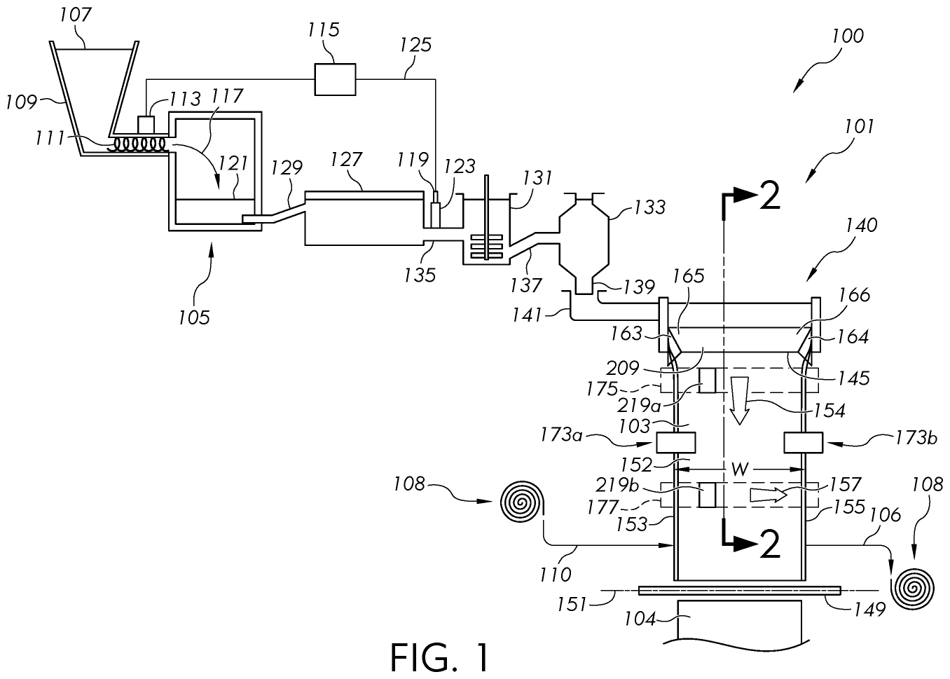

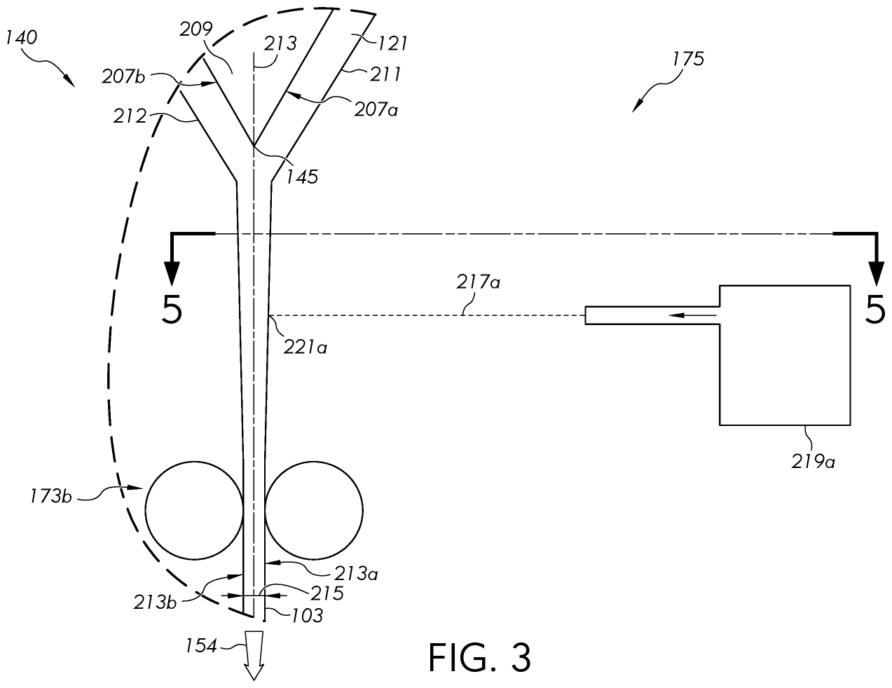

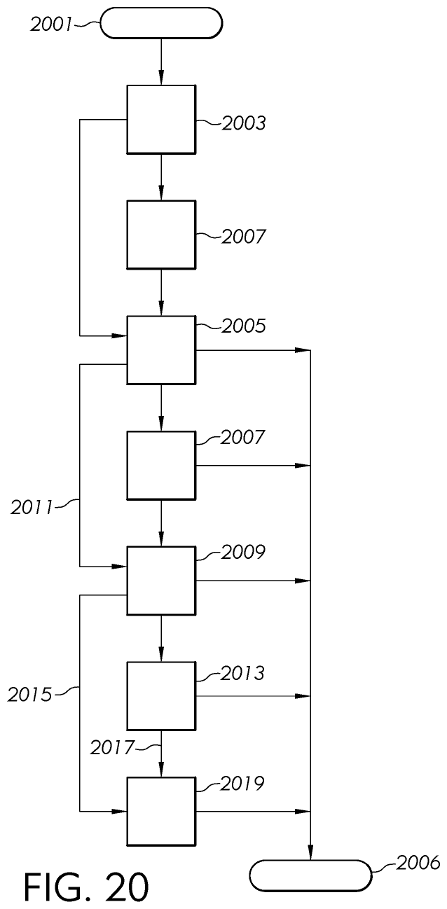

Embodiments of methods of making the foldable apparatus in accordance with embodiments of the disclosure will be discussed with reference to the flow chart in FIG. 20 and example method steps illustrated in FIGS. 1-7.

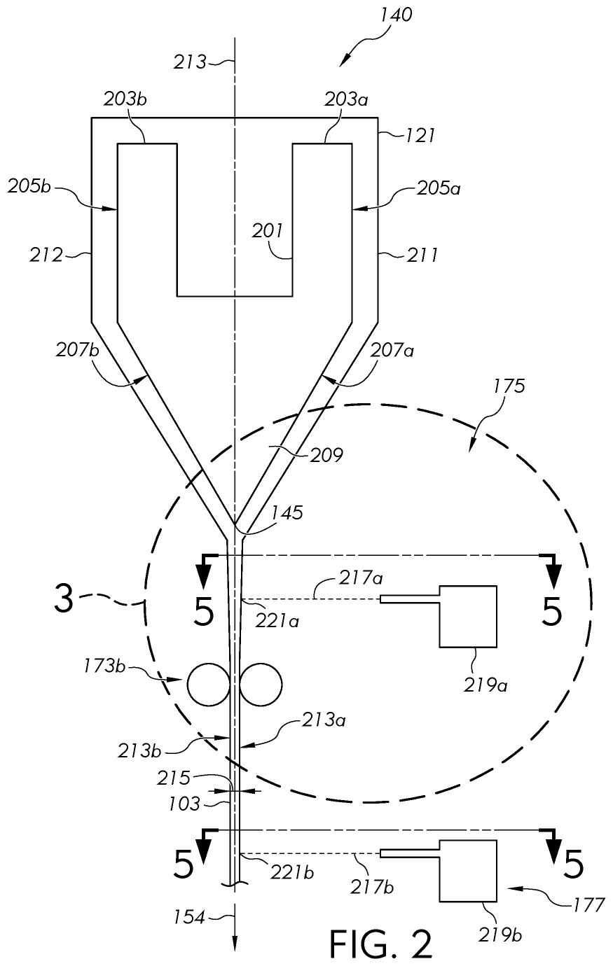

As shown in FIG. 20, the method can begin at 2001 with the step 2003 of providing a glass-based ribbon. As shown in FIGS. 1-2, the glass-based ribbon can be provided as a drawn glass-based ribbon 103 that is drawn from a quantity of molten material 121 off a forming device 140 of a glass forming apparatus 101 of a glass manufacturing apparatus 100 to travel in a draw direction 154. Various glass manufacturing apparatus may be used if the step 2003 of providing the glass-based ribbon comprises forming the glass-based ribbon by drawing the glass-based ribbon 103 from the quantity of molten material 121. Various alternative forming devices 140 may be used to produce the glass-based ribbon 103. For example, as illustrated in FIG. 1, the forming device 140 comprises a down-draw device (e.g., fusion down-draw device). Although not shown, the forming device may alternatively comprise a slot draw device, float bath device, up-draw device, press-rolling device, or other forming devices that can be used to form a glass-based ribbon from a quantity of molten material. In some embodiments, the glass-based ribbon can be processed into a foldable substrate that can, for example, provide a cover for one or more of the above-referenced devices or other applications.

An example method of drawing a glass-based ribbon will be described with the glass manufacturing apparatus 100 illustrated in FIGS. 1-2 with the understanding that other glass manufacturing apparatus may be used in further embodiments. As schematically illustrated in FIG. 1, in some embodiments, the glass manufacturing apparatus 100 can include the glass forming apparatus 101 including the forming device 140 designed to produce a drawn glass-based ribbon 103 of molten material from the quantity of molten material 121. In some embodiments, the drawn glass-based ribbon 103 can include a central portion 152 disposed between a first outer edge 153 and a second outer edge 155. Additionally, in some embodiments, a glass-based ribbon 104 can be separated from the drawn glass-based ribbon 103 along a separation path 151 by a glass separator 149 (e.g., scribe, score wheel, laser). In some embodiments, as demonstrated by arrow 106, rather than being separated into the separated glass-based ribbon 104, a longer length of the glass-based ribbon 103 can be coiled onto a storage roll as a coiled spool 108 of glass-based ribbon 103. The coiled spool 108 can help store a large quantity of glass-based ribbon 103 for subsequent processing into the separated glass-based ribbon 104. For example, as shown schematically in FIG. 1, rather than separating the glass-based ribbons 104 in-line as the glass-based ribbon 103 is drawn from the forming device 140, the coiled spool 108 of glass-based ribbon 103 can be unwound from the coiled spool 108 as indicated by arrow 110. The unwound glass-based ribbon can then be separated along separation path 151 by the glass separator 149 (e.g., at another location) that may not include other components of the glass manufacturing apparatus 100 illustrated in FIG.

1.

In some embodiments, the glass manufacturing apparatus 100 can include a melting vessel 105 oriented to receive batch material 107 from a storage bin 109. The batch material 107 can be introduced by a batch delivery device 111 powered by a motor 113. In some embodiments, a controller 115 can optionally be operated to activate the motor 113 to introduce an amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 100 can include a first conditioning station including a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 100 can further include a second conditioning station including a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass manufacturing apparatus 100 can include a third conditioning station including a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 can be positioned to deliver molten material 121 from the delivery vessel 133 to the inlet conduit 141 of the forming device 140.

Various embodiments of forming devices can be provided in accordance with features of the disclosure including a forming device with a wedge for fusion drawing the ribbon of molten material, a forming device with a slot to slot draw the ribbon of molten material, or a forming device provided with press rolls to press roll the ribbon of molten material from the forming device. By way of illustration, the forming device 140 shown and disclosed below can be provided to fusion draw the molten material 121 off a bottom edge (e.g., root 145) of a forming wedge 209 to produce the glass-based ribbon 103. For example, in some embodiments, the molten material 121 can be delivered from the inlet conduit 141 to the forming device 140. The molten material 121 can then be formed into glass-based ribbon 103 based at least in part on the structure of the forming device 140. For example, as shown, the molten material 121 can be drawn off the root 145 of the forming device 140 along a draw path extending in the draw direction 154 of the glass manufacturing apparatus 100. In some embodiments, edge directors 163, 164 can direct the molten material 121 off the forming device 140 and define, at least in part, a width “W” of the glass-based ribbon 103. In some embodiments, the width “W” of the glass-based ribbon 103 of molten material can extend between the first outer edge 153 of the glass-based ribbon 103 and the second outer edge 155 of the glass-based ribbon 103. In some embodiments, the forming device 140 can comprise a ceramic refractory material, for example, zircon, zirconia, mullite, alumina, or combinations thereof. In some embodiments, the forming device 140 can comprise a metal, for example, platinum, rhodium, iridium, osmium, palladium, ruthenium, or combinations thereof. In further embodiments, one or more surfaces of the forming device 140 can comprise a metal to provide a non-reactive surface that can contact the molten material 121.

In some embodiments, the width “W” of glass-based ribbon 103 can be about 20 mm or more, about 50 mm or more, about 100 mm or more, about 500 mm or more, about 1,000 mm or more, about 2,000 mm or more, about 3,000 mm or more, about 4000 mm or more, although other widths can be provided in further embodiments. In some embodiments, the width “W” of the glass-based ribbon 103 can be in a range from about 20 mm to about 4,000 mm, from about 50 mm to about 4,000 mm, from about 100 mm to about 4,000 mm, from about 100 mm to about 3,000 mm, from about 500 mm to about 3,000 mm, from about 1,000 mm to about 3,000 mm, from about 2,000 mm to about 3,000 mm, from about 2,000 mm to about 2,500 mm, or any range or subrange therebetween.

FIG. 2 shows a cross-sectional perspective view of the glass manufacturing apparatus 100 along line 2-2 of FIG. 1, according to various embodiments of the disclosure. In some embodiments, the forming device 140 can include a trough 201 oriented to receive the molten material 121 from the inlet conduit 141. The forming device 140 can further include the forming wedge 209 including a pair of downwardly inclined converging surface portions 207a, 207b extending between opposed ends 165, 166 (see FIG. 1) of the forming wedge 209. The pair of downwardly inclined converging surface portions 207a, 207b of the forming wedge 209 can converge along the draw direction 154 to intersect along a bottom edge of the forming wedge 209 to define the root 145 of the forming device 140. A draw plane 213 of the glass manufacturing apparatus 100 can extend through the root 145 along the draw direction 154. In some embodiments, the glass-based ribbon 103 can be drawn in the draw direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 flows into the trough 201 of the forming device 140 and then overflows from the trough 201 by simultaneously flowing over weirs 203a, 203b and downward over the outer surfaces 205a, 205b of the weirs 203a, 203b. Respective streams 211, 212 of molten material 121 flow along corresponding downwardly inclined converging surface portions 207a, 207b of the forming wedge 209 to be drawn off the root 145 of the forming device 140, where the streams 211, 212 of molten material 121 converge and fuse into the glass-based ribbon 103. The glass-based ribbon 103 can then be drawn off the root 145 in the draw plane 213 along the draw direction 154.

In some embodiments, although not shown, the forming device 140 can comprise a pipe oriented to receive the molten material 121 from the inlet conduit 141. In some embodiments, the pipe can comprise a slot through which molten material 121 can flow. For example, the slot can comprise an elongated slot that extends along an axis of the pipe at the top of the pipe. In some embodiments, a first wall can be attached to the pipe at a first peripheral location and a second wall can be attached to the pipe at a second peripheral location. The first wall and the second wall can comprise a pair of downwardly inclined converging surface portions. The first wall and the second wall can also at least partially define a hollow region within the forming device. In some embodiments, a pipe wall comprising the pipe, the first wall, and/or the second wall can comprise a thickness in a range from about 0.5 mm to about 10 mm, from about 0.5 mm to about 7 mm, from about 1 mm to about 7 mm, from about 3 mm to about 7 mm, or any range or subrange therebetween. A thickness in the above range can result in overall reduced material costs compared to embodiments comprising thicker walls.

In some embodiments, the glass-based ribbon 103 can cool from a glass-based molten ribbon (at the root 145) to the glass-based ribbon 103 in an elastic phase. As mentioned previously, in some embodiments, the glass separator 149 (see FIG. 1) can then separate the glass-based ribbon 104 from the glass-based ribbon 103 along the separation path 151. As illustrated, in some embodiments, the separation path 151 can extend along the width “W” of the glass-based ribbon 103 between the first outer edge 153 and the second outer edge 155. Additionally, in some embodiments, the separation path 151 can extend perpendicular to the draw direction 154 of the glass-based ribbon 103. Moreover, in some embodiments, the draw direction 154 can define a direction along which the glass-based ribbon 103 can be fusion drawn from the forming device 140. In some embodiments, the glass-based ribbon 103 can include a speed as it traverses along draw direction 154 of about 1 millimeters per second (mm/s) or more, about 10 mm/s or more, about 50 mm/s or more, about 100 mm/s or more, or about 500 mm/s or more, for example, in a range from about 1 mm/s to about 500 mm/s, from about 10 mm/s to about 500 mm/s, from about 50 mm/s to about 500 mm/s, from about 100 mm/s to about 500 mm/s, or any range or subrange therebetween.

As shown in FIG. 2, in some embodiments, the glass-based ribbon 103 can be drawn from the root 145 with a first major surface 213a of the glass-based ribbon 103 and a second major surface 213b of the glass-based ribbon 103 facing opposite directions and defining an average thickness 215 of the glass-based ribbon 103. In some embodiments, the average thickness 215 of the central portion 152 of the glass-based ribbon 103 can be about 3 mm or less, about 2 mm or less, about 1 mm or less, about 500 μm or less, a bout 300 μm or less, about 200 μm or less, or about 100 μm or less, although other thicknesses may be provided in further embodiments. For example, in some embodiments, the average thickness 215 of the glass-based ribbon 103 can be in a range from about 25 μm to about 750 μm, from about 100 μm to about 700 μm, from about 200 μm to about 600 μm, from about 300 μm to about 500 μm, from about 25 μm to about 500 μm, from about 25 μm to about 700 μm, from about 25 μm to about 600 μm, from about 25 μm to about 500 μm, from about 25 μm to about 400 μm, from about 25 μm to about 300 μm, from about 25 μm to about 200 μm, or from about 25 μm to about 100 μm, from about 50 μm to about 750 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, or from about 50 μm to about 100 μm, or any range or subrange therebetween. In some embodiments, the average thickness 215 of the glass-based ribbon 103 can be in one of the ranges discussed above with regards to substrate thickness 901, 2201.

Also, as shown in FIG. 1, the glass manufacturing apparatus 100 may comprise two pairs of pull rollers (e.g., a first pair of pull rollers 173a contacting a first edge portion comprising the first outer edge 153 and a second pair of pull rollers 173b contacting a second edge portion comprising the second outer edge 155). As used herein, “upstream” and “downstream” are terms used to describe relations based on the draw direction 154. For example, in some embodiments, the two pairs of pull rollers 173a, 173b may be located downstream from the forming device 140 as shown in FIG. 1. In some embodiments, the two pairs of pull rollers 173a, 173b an exert a pulling force in the draw direction 154 to obtain a predetermined thickness (e.g., average thickness 215) of the glass-based ribbon 103, which can be within the thickness range discussed above.

Example embodiments of the molten material 121, which may be free of lithia or not, can comprise soda lime molten material, aluminosilicate molten material, alkali-aluminosilicate molten material, borosilicate molten material, alkali-borosilicate molten material, alkali-alumniophosphosilicate molten material, or alkali-aluminoborosilicate glass molten material. In one or more embodiments, the molten material 121 may comprise, in mole percent (mol %): SiO₂ in a range from about 40 mol % to about 80%, Al₂O₃ in a range from about 10 mol % to about 30 mol %, B₂O₃ in a range from about 0 mol % to about 10 mol %, ZrO₂ in a range from about 0 mol% to about 5 mol %, P₂O₅ in a range from about 0 mol % to about 15 mol %, TiO₂ in a range from about 0 mol % to about 2 mol %, R₂O in a range from about 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In some embodiments, the molten material 121 may optionally further comprise in a range from about 0 mol % to about 2 mol %, any one or more of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. In some embodiments, the glass-based ribbon 103 may be transparent, meaning that the glass-based ribbon 103 drawn from the molten material 121 can comprise an average light transmission over the optical wavelengths from 400 nanometers (nm) to 700 nm of about 85% or greater, about 86% or greater, about 87% or greater, about 88% or greater, about 89% or greater, about 90% or greater, about 91% or greater, or about 92% or greater.

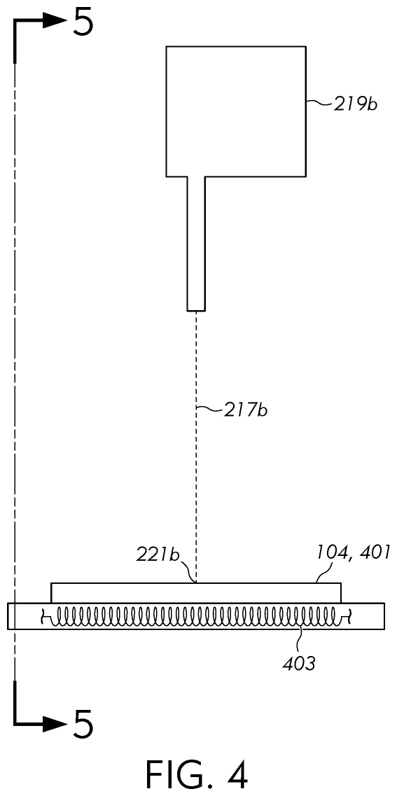

Referring again to FIG. 20, the method of making a foldable apparatus can begin at 2001 with the step 2003 of providing the glass-based ribbon. As discussed above, with reference to FIGS. 1-2, the step 2003 of providing the glass-based ribbon can provide the glass-based ribbon 103 as the drawn glass-based ribbon 103 that is drawn from the quantity of molten material 121 off the forming device 140 to travel in a draw direction 154. In further embodiments, the step 2003 of providing the glass-based ribbon can provide the glass-based ribbon as a separated glass-based ribbon 104 that is separated from the drawn glass-based ribbon 103. Alternatively, the step 2003 of providing the glass-based ribbon can provide the glass-based ribbon 103 as an uncoiled glass-based ribbon 103 that is uncoiled from the coiled spool 108. Alternatively, the step 2003 of providing the glass-based ribbon can provide the glass-based ribbon as a separated glass-based ribbon 104 that is separated from the glass-based ribbon uncoiled from the coiled spool 108. In some embodiments, as shown in FIG. 4, the step 2003 of providing the glass-based ribbon can comprise providing the separated glass-based ribbon 104 or providing a glass-based ribbon 401 that is obtained from inventory and/or obtained from another location (e.g., purchased from a third party). The step of providing may include either manufacturing of the glass-based ribbon or otherwise obtaining the glass-based ribbon as by purchase, for example.

As shown in FIG. 20, in some embodiments, the method of making the foldable apparatus 801, 1001, 1101, 2101, 2302, and/or 2401 can proceed from the step 2003 of providing the glass-based ribbon to the step 2005 of forming groove(s) in the glass-based ribbon to form a foldable substrate 803 or 2103 as shown in FIG. 8-11 or 21-24.

The step 2005 of forming the groove(s) (e.g., plurality of grooves 815, groove 2115) in the glass-based ribbon to form a foldable substrate 803 or 2103 can be conducted with a laser (e.g., one or more lasers) using a wide range of techniques. The various techniques include the steps of emitting a laser beam from a laser and impinging a target location of the glass-based ribbon with the laser beam to form the plurality of grooves in the glass-based ribbon.

In some embodiments, as shown in FIG. 1, the groove(s) (e.g., plurality of grooves 815, groove 2115) may be formed in the glass-based ribbon 103 being drawn from the forming device 140 prior to separating the glass-based ribbon from the drawn glass-based ribbon 103 traveling from the forming device 140. In some embodiments, the methods can impinge the target location of the glass-based ribbon 103 traveling in the draw direction 154 with the laser beam to form the plurality of grooves 815 in the drawn glass-based ribbon 103.

In some embodiments, as schematically illustrated in FIGS. 1-2 within a first zone 175, a target location 221a (see FIG. 2) of the glass-based ribbon 103 can comprise a viscosity in a range from about 10³ Pascal-seconds (Pa-s) to about 10^{6.6} Pa-s at which point a laser beam 217a emitted from a laser 219a may be directed so as to initially begin impinging the target location 221a of the glass-based ribbon 103 as the glass-based ribbon 103 is traveling in the draw direction 154. In some embodiments, as shown in FIG. 2, the laser beam 217a emitted from the laser 219a can impinge the target location 221a of the traveling glass-based ribbon 103 with the laser beam 217a to create the groove(s) (e.g., plurality of grooves 815, groove 2115). In some embodiments, the glass-based ribbon 103 may comprise a viscosity below its softening point viscosity and/or above its working point viscosity. In some embodiments, the method can comprise contacting the glass-based ribbon 103 with pull rollers 173a, 173b that exert a pulling force in the draw direction 154 to obtain a predetermined thickness (e.g., average thickness 215) of the glass-based ribbon 103 while the target location 221a is positioned: (i) at an elevation between the forming device 140 and the pull rollers 173a, 173b; and (ii) downstream from the forming device 140 and upstream from the pull rollers 173a, 173b. Providing the target location 221a with a viscosity in the range from about 10³ Pa-s to about 10^{6.6} Pa-s and/or at a location between the forming device 140 and the pull rollers 173a, 173b can help the laser beam 217a decrease the thickness of the glass-based ribbon 103 at the target location 221a by heating the target location 221a to decrease a viscosity of the target location 221a of the glass-based ribbon 103. The decrease in thickness can create the plurality of grooves 815 in the glass-based ribbon 103.

In some embodiments, as schematically illustrated by a second zone 177, a target location 221b of the glass-based ribbon 103 can comprise a viscosity in a range from about 10¹¹ Pa-s to about 10¹⁴ Pa-s at which point a laser beam 217b emitted from laser 219b may be directed so as to initially begin impinging the target location 221b of the glass-based ribbon 103 traveling in the draw direction 154. In some embodiments, the glass-based ribbon 103 may comprise a viscosity below its strain point viscosity and/or above its annealing point viscosity. In some embodiments, as shown in FIG. 2, the laser beam 217b emitted from the laser 219b can impinge the target location 221b of the traveling glass-based ribbon 103 with the laser beam 217b to create the groove(s) (e.g., plurality of grooves 815, groove 2115). In some embodiments, the method can comprise contacting the glass-based ribbon 103 with pull rollers 173a, 173b that exert the pulling force in the draw direction 154 to obtain the predetermined thickness (e.g., average thickness 215) of the glass-based ribbon 103 where the pull rollers 173a, 173b are positioned between the target location 221b and the forming device 140 where the pull rollers 173a, 173b are positioned downstream from the forming device 140 and the target location 221b is positioned downstream from the pull rollers 173a, 173b. Providing the target location 221a with a viscosity in the range from about 10¹¹ Pa-s to about 10¹⁴ Pa-s and/or at a location where the pull rollers 173a, 173b are positioned between the target location 221b and the forming device 140 can help the laser beam 217b to ablate the glass-based ribbon 103 at the target location 221b to form the plurality of grooves 815.

In some embodiments, the target location of the glass-based ribbon 103 can be in the glassy elastic phase, for example, a glassy phase that exists at a temperature of 20 degrees Celsius (° C.) when initially beginning to impinge the target location of the glass-based ribbon 103 traveling in the draw direction 154 with a laser beam emitted from a laser to help the laser beam ablate the glass-based ribbon 103 at the target location to form the groove(s) (e.g., plurality of grooves 815, groove 2115).

In some embodiments, heating devices and/or cooling devices may be provided to help control the viscosity of the glass-based ribbon 103 to be within a predetermined range of viscosities to permit thinning of the glass-based ribbon 103 to provide the groove(s) (e.g., plurality of grooves 815, groove 2115) within the first zone 175 or to permit ablation of portions of the glass-based ribbon 103 to provide the groove(s) (e.g., plurality of grooves 815, groove 2115) within the second zone 177. In addition, or alternatively, the heating devices may control the temperature of the glass-based ribbon in further embodiments. For example, as shown in FIG. 4, a glass-based ribbon 401, for example, the separated glass-based ribbon 104 from the drawn glass-based ribbon 103 discussed above, can be heated with a heater 403 (e.g., resistance heater) to bring the target location 221b of the glass-based ribbon to a heated temperature of about 500 degrees Celsius (° C.) or more and, in some embodiments, a viscosity in the range from about 10¹¹ Pa-s to about 10¹⁴ Pa-s. Thus, as indicated by step 2007 in FIG. 20, the method may include heating the glass-based ribbon to provide the target location of the glass-based ribbon at a temperature of about 500° C. or more and, in some embodiments, a viscosity in the range from about 10¹¹ Pa-s to about 10¹⁴ Pa-s when initially beginning to impinge the target location with the laser beam. Alternatively, in second zone 177, the temperature of the target location 221b may already comprise a temperature of about 500° C. or more and, in some embodiments, a viscosity in the range from about 10¹¹ Pa-s to about 10¹⁴ Pa-s. In some embodiments, as in the second zone 177, the temperature of the target location 221b may comprise a temperature of about 500° C. or more and, in some embodiments, a viscosity in the range from about 10¹¹ Pa-s to about 10¹⁴ Pa-s while the ribbon cools from being drawn off the forming device 140 before cooling below 500° C. after being drawn from the forming device 140. Alternatively, if the drawn glass-based ribbon cools below 500° C. and, in some embodiments, the viscosity of the drawn glass-based ribbon is greater than about 10¹⁴ Pa-s or has fully cooled to the glassy elastic stage (e.g., cools to room temperature), the glass-based ribbon 103 may be reheated with heaters to a temperature of about 500° C. or more and, in some embodiments, reheated to a viscosity of from about 10¹¹ Pa-s to about 10¹⁴ Pa-s prior to being separated from the drawn glass-based ribbon. Still further, as shown in FIG. 4, a fully cooled separated glass-based ribbon 104 separated from the drawn glass-based ribbon 103 may be reheated with heaters to a temperature of about 500° C. or more and, in some embodiments, a viscosity in the range from about 10¹¹ Pa-s to about 10¹⁴ Pa-s.

Thus, in some embodiments, the method of making the foldable apparatus can include providing the glass-based ribbon 103, 104, 401 at a heated temperature of about 500° C. or more and emitting the laser beam 217b from the laser 219b. The methods can include impinging the target location 221b of the glass-based ribbon 103, 104, 401 with the laser beam 217b to form the groove(s) (e.g., plurality of grooves 815, groove 2115) in the glass-based ribbon 103, 104, 401 (e.g., by ablation), wherein glass-based ribbon 103, 104, 401 forms a foldable substrate 803 or 2103 (e.g., foldable glass-based substrate, foldable ceramic-based substrate), and the target location 221b of the foldable substrate 803 or 2103 is at the heated temperature when initially beginning to impinge the target location 221b with the laser beam 217b. In some embodiments, the groove(s) formed can comprise the plurality of grooves 815 comprising the groove depth 911, groove width 821, groove length 823, and/or groove spacing 817 discussed above. In some embodiments, the groove(s) formed can comprise a single groove 2115 per foldable substrate, and the single groove 2115 can comprise the groove depth 2222, groove width, and/or groove length discussed above, although multiple foldable substrates can be made from ribbon. Furthermore, in some embodiments, the target location 221b of the glass-based ribbon 103, 104, 401 can comprise a viscosity in a range from about 10¹¹ Pa-s to about 10¹⁴ Pa-s when initially beginning to impinge the target location 221b with the laser beam 217b. In some embodiments, the foldable substrate 803 or 2103 can comprise a foldable glass-based substrate. In further embodiments, the foldable glass-based substrate may be transformed into a foldable ceramic-based substrate as described above.

Providing the target location of the glass-based ribbon at a temperature of about 500° C. or more and, in some embodiments, a viscosity in the range from about 10¹¹ Pa-s to about 10¹⁴ Pa-s when initially beginning to impinge the target location with the laser beam can be beneficial when forming the plurality of grooves in the glass-based ribbon (e.g., by ablation). For example, surface cracks (e.g., micro-cracks) or other surface imperfections at or near the groove surface may be generated at temperatures below 500° C. and, in some embodiments having a viscosity greater than about 10¹⁴ Pa-s or has partially or fully cooled to the glassy elastic stage (e.g., cools to room temperature). However, such surface cracks (e.g., micro-cracks) or other surface imperfections can be avoided and/or healed (e.g., when ablating the plurality of grooves) when initially beginning to impinge the target location with the laser beam at a temperature of about 500° C. or more and, in some embodiments, a viscosity in the range from about 10¹¹ Pa-s to about 10¹⁴ Pa-s. For example, the nature of the heated glass-based ribbon may reduce stress concentrations during the groove formation process with the laser beam to avoid forming surface cracks (e.g., micro-cracks) or other surface imperfections that would result from initially beginning to impinge the target location with the laser beam while the target location is at a temperature below 500° C. and/or having a viscosity greater than about 10¹⁴ Pa-s or has fully cooled to the glassy elastic stage. Furthermore, the nature of the heated glass-based ribbon may result in self-healing of surface cracks (e.g., micro-cracks) or other surface imperfections produced during the process of forming the plurality of grooves that may not otherwise self-heal if initially beginning to impinge the target location with the laser beam while the target location is at a temperature below 500° C. and/or having a viscosity greater than about 10¹⁴ Pa-s or has fully cooled to the glassy elastic stage. Consequently, providing the target location of the glass-based ribbon at a temperature of about 500° C. or more and, in some embodiments, a viscosity in the range from about 10¹¹ Pa-s to about 10¹⁴ Pa-s when initially beginning to impinge the target location with the laser beam can be beneficial to avoid formation of surface cracks (e.g., micro-cracks) or other surface imperfections and/or self-heal formed surface cracks (e.g., micro-cracks) or other surface imperfections in embodiments when the laser beam forms the plurality of grooves, e.g., by ablating portions of the glass-based ribbon. Reducing formation of surface cracks (e.g., micro-cracks) or other surface imperfections and/or self-healing formed surface cracks (e.g., micro-cracks) or other surface imperfections can reduce failure initiation points and thus reduce the probability of failure at the central portion and/or provide a smaller effective minimum bend radius than may otherwise be achieved with the existence of surface cracks (e.g., micro-cracks) or other surface imperfections.

Various types of lasers throughout the disclosure may be used in accordance with embodiments of the disclosure that may be used to ablate or thin the glass ribbon. For example, in some embodiments, the laser 219a, 219b may be configured to emit a laser beam comprising a wavelength in a range from about 1 μm to about 20 μm, from about 4 μm to about 20 μm, from about 4 μm to about 16 μm, from about 4 μm to about 12 μm, from about 8 μm to about 12 μm, or any range or subrange therebetween. In some embodiments, the laser 219a, 219b may comprise a carbon dioxide (CO₂) laser or a carbon monoxide (CO) laser. In some embodiments, the laser 219b may comprise an ultrafast laser that may be used to ablate the groove(s) into the glass-based ribbon. In further embodiments, the ultrafast laser may have a pulse width of from about 10⁻¹² to about 10¹⁵ seconds and a peak intensity of greater than 10¹³ Watts/centimeter².

In some embodiments, the laser 219a, 219b can comprise a gas laser, an excimer laser, a dye laser, or a solid-state laser. Example embodiments of gas lasers include helium, neon, argon, krypton, xenon, helium-neon (HeNe), xenon-neon (XeNe), carbon dioxide (CO₂), carbon monoxide (CO), copper (Cu) vapor, gold (Au) vapor, cadmium (Cd) vapor, ammonia, hydrogen fluoride (HF), and deuterium fluoride (DF). Example embodiments of excimer lasers include chlorine, fluorine, iodine, or dinitrogen oxide (N₂O) in an inert environment comprising argon (Ar), krypton (Kr), xenon (Xe), or a combination thereof. Example embodiments of dye lasers include those using organic dyes, for example, rhodamine, fluorescein, coumarin, stilbene, umbelliferone, tetracene, or malachite green dissolved in a liquid solvent. Example embodiments of solid-state lasers include crystal lasers, fiber lasers, and laser diodes. Crystal-based lasers comprise a host crystal doped with a lanthanide or a transition metal. Example embodiments of host crystals include yttrium aluminum garnet (YAG), yttrium lithium fluoride (YLF), yttrium othoaluminate (YAL), yttrium scandium gallium garnet (YSSG), lithium aluminum hexafluoride (LiSAF), lithium calcium aluminum hexafluoride (LiCAF), zinc selenium (ZnSe), zinc sulfide (ZnS), ruby, forsterite, and sapphire. Example embodiments of dopants include neodymium (Nd), titanium (Ti), chromium (Cr), cobalt (Co), iron (Fe), erbium (Er), holmium (Ho), thulium (Tm), ytterbium (Yb), dysprosium (Dy), cerium (Ce), gadolinium (Gd), samarium (Sm), and terbium (Tb). Example embodiments of solid crystals include ruby, alexandrite, chromium fluoride, forsterite, lithium fluoride (LiF), sodium chloride (NaCl), potassium chloride (KCl), and rubidium chloride (RbCl). Laser diodes can comprise heterojunction or PIN diodes with three or more materials for the respective p-type, intrinsic, and n-type semiconductor layers. Example embodiments of laser diodes include AlGaInP, AlGaAs, InGaN, InGaAs, InGaAsP, InGaAsN, InGaAsNSb, GaInP, GaAlAs, GaInAsSb, and lead (Pb) salts. Some laser diodes can represent exemplary embodiments because of their size, tunable output power, and ability to operate at room temperature (i.e., about 20° C. to about 25° C.). As described below, fiber lasers comprise an optical fiber further comprising a cladding with any of the materials listed above for crystal lasers or laser diodes.

In some embodiments, the laser 219a, 219b may be configured to emit a laser beam comprising a wavelength in a range from about 1 μm to about 20 μm. In further embodiments, the wavelength can be about 1 μm or more, about4 μm or more, about 6 μm or more, about 8 μm or more, about 20 μm or less, about 16 μm or less, or about 12 μm or less. In further embodiments, the wavelength can be in a range from about 1 μm to about 20 μm, from about 4 μm to about 20 μm, from about 4 μm to about 16 μm, from about 6 μm to about 16 μm, from about 8 μm to about 16 μm, from about 8 μm to about 12 μm, or any range or subrange therebetween. An exemplary embodiment of laser configured to emit a laser beam comprising a wavelength in a range from about 1 μm to about 20 μm is a carbon dioxide laser. Providing a laser configured to emit a laser beam comprising a wavelength in a range from about 1 μm to about 20 μm (e.g., from about 4 μm to about 20 μm) can produce well-defined features when the grooves are formed by decreasing the thickness of the glass-based ribbon by increasing a viscosity of the material at the target location because, without wishing to be bound by theory, glass-based materials may strongly absorb wavelengths in this range, which can limit the depth of glass-based ribbon effected to a region near the surface of the glass-based ribbon.

In some embodiments, the laser 219a, 219b may be configured to emit a laser beam comprising a wavelength in a range from about 350 nanometers (nm) to about 1,700 nm. In some embodiments, the wavelength can be about 350 nm or more, about 500 nm or more, about 760 nm or more, about 980 nm or more, about 1,700 nm or less, about 1,570 nm or less, about 1,100 nm or less, or about 980 nm or less. In some embodiments, the wavelength can be in a range from about 350 nm to about 1,700 nm, from about 500 nm to about 1,700 nm, from about 500 nm to about 1,570 nm, from about 760 nm to about 1,570 nm, from about 980 nm to about 1,570 nm, from about 350 nm to about 1,100 nm, from about 500 nm to about 1,100 nm, from about 760 nm to about 1,100 nm, from about 980 nm to about 1,100 nm, from about 350 nm to about 980 nm, from about 500 nm to about 980 nm, from about 760 nm to about 980 nm, or any range or subrange therebetween. Exemplary embodiments of a laser diode capable of producing a laser beam with a wavelength within the aforementioned ranges include an AlGaAs, an InGaAsP, an InGaAsN laser diode. Exemplary embodiments of a laser (other than a diode laser) capable of producing a laser beam with a wavelength within the aforementioned ranges include a He—Ne gas laser, an Ar gas laser, an iodine excimer laser, a Nd doped YAG solid-state laser, a Nd doped YLF solid-state laser, a Nd doped YAP solid-state laser, a Ti doped sapphire solid-state laser, a Cr doped LiSAF solid-state laser, a chromium fluoride solid-state laser, a forsterite solid-state laser, a LiF solid-state laser, and a NaCl solid-state laser. Exemplary embodiments of a laser that can produce a laser beam with a wavelength within the aforementioned ranges when frequency-doubled include a XeNe gas laser, a HF gas laser, a Ho doped YAG solid-state laser, an Er doped YAG solid-state laser, a Tm doped YAG solid-state laser, a KCl solid-state laser, a RbCl solid-state laser, and an AlGaIn laser diode. Exemplary embodiments of a laser that can produce a laser beam with a wavelength within the aforementioned ranges when frequency-tripled include a HeNe gas laser, a DF gas laser, and a Pb salt laser diode. Providing a laser configured to emit a laser beam comprising a wavelength in a range from about 350 nm to about 1,700 nm can produce well-defined features when the grooves are formed by ablation because, without wishing to be bound by theory, glass-based materials may weakly absorb wavelengths in this range, which can enhance groove formation through non-linear absorption associated with ablation with minimal side-effects to the glass-based ribbon.

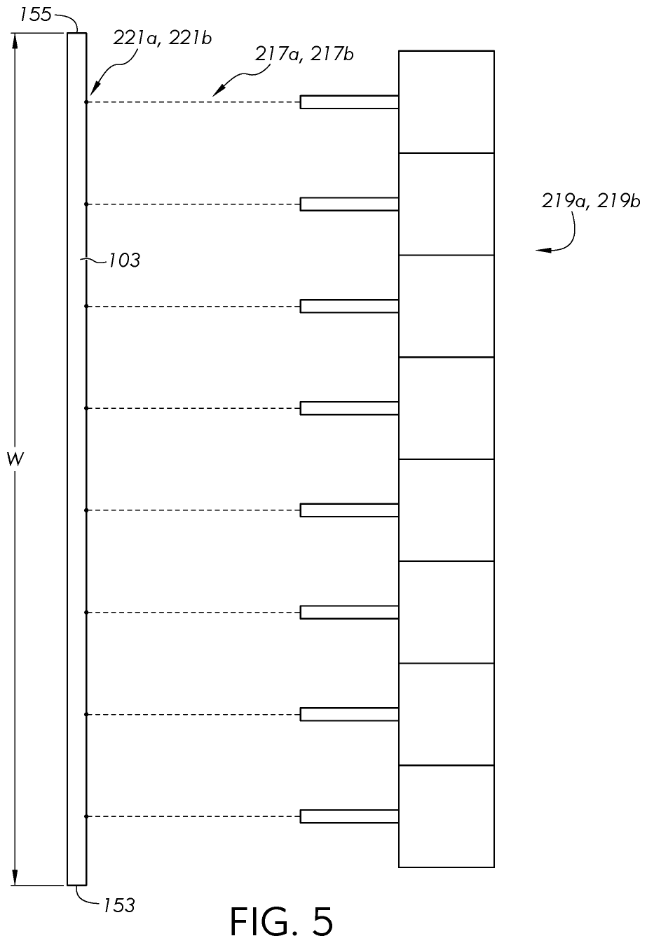

In some embodiments, forming the groove(s) (e.g., plurality of grooves 815, groove 2115) can be conducted by scanning the laser beam 217a, 217b. For example, with reference to FIGS. 1-2, one or more laser beams 217a, 217b may be scanned in a direction 157 transverse (e.g., perpendicular) to the draw direction 154. In some embodiments, one or more lasers may be scanned a single time to form the groove(s) (e.g., plurality of grooves 815, groove 2115), for example, when a duration of a pulse of the one or more laser beams 217a, 217b is adjusted to generate a predetermined design for the groove(s) (e.g., plurality of grooves 815, groove 2115). In further embodiments, impinging the target location 221a, 221b can comprise impinging a plurality of target locations of the glass-based ribbon 103 with the laser beam 217a, 217b. In some embodiments, as discussed below with reference to FIG. 5-6 and FIG. 7, one or more lasers can be used to form the one or more grooves such that the groove length 823 extends in the draw direction 154, although the one or more lasers can be operated such that the groove length 823 extends transverse to the draw direction in other embodiments.

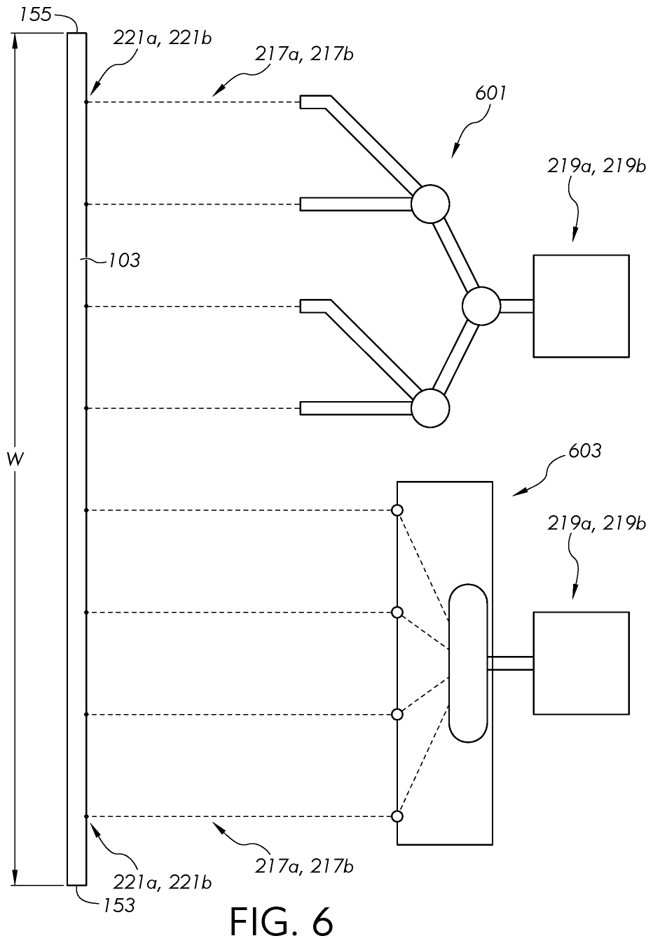

FIG. 5 illustrates some embodiments where the laser beam 217a, 217b comprises a plurality of laser beams that are each produced by a corresponding laser 219a, 219b. As further shown in FIG. 5, each laser beam 217a, 217b of the plurality of laser beams can impinge a corresponding target location 221a, 221b of the plurality of target locations during the step of impinging the target location. FIG. 6 illustrates some embodiments where the laser beam 217a, 217b comprises a plurality of laser beams that are each produced by a beam splitter 601 produced by a laser 219a, 219b. FIG. 6 illustrates some further embodiments where the laser beam 217a, 217b comprises a plurality of laser beams that are each produced emitting a laser beam from a laser 219a, 219b that is passed through a fisheye lens 603 and filtered (e.g., collimated) into a plurality of laser beams 217a, 217b. For example, the plurality of laser beams 217a, 217b can simultaneously form a plurality of parallel grooves that extend in the draw direction 154 such that the groove length 823 extends in the draw direction 154 to form the foldable substrate 803 shown in FIGS. 8-10. For example, if the plurality of laser beams 217a, 217b are sufficiently close to one another, the foldable substrate 2103 shown in FIGS. 21-24 can be formed either in the draw direction 154 or transverse to the draw direction 154.

As shown in FIGS. 5-6, the plurality of grooves 815 may be simultaneously formed by the plurality of laser beams 217a, 217b simultaneously impinging on a plurality of target locations 221a, 221b that may be spaced apart along the width “W” of the glass-based ribbon 103 while relative movement between the plurality of laser beams 217a, 217b and the glass-based ribbon 103 may be provided by the glass-based ribbon 103 being drawn in the draw direction 154 relative to the plurality of laser beams 217a, 217b. In further embodiments, the plurality of target locations 221a, 221b may be spaced apart in a direction 157 transverse to the draw direction 154 so that a distinct groove of the plurality of grooves 815 is formed. In some embodiments, as the glass-based ribbon 103 is traveling in the draw direction 154 from the forming device 140, the plurality of laser beams 217a, 217b can simultaneously form a plurality of parallel grooves that extend in the draw direction 154. The lasers 219a, 219b can be periodically turned on and/or off (e.g., controlling a width of a pulse of a laser beam emitted from the laser) to create each groove of the plurality of grooves or set of plurality of grooves. Forming the plurality of grooves simultaneously and/or forming the plurality of grooves while the drawn glass-based ribbon 103 is being drawn from the forming device 140, prior to separating the glass-based ribbon, can contribute to reducing processing time and expense associated with forming the grooves.

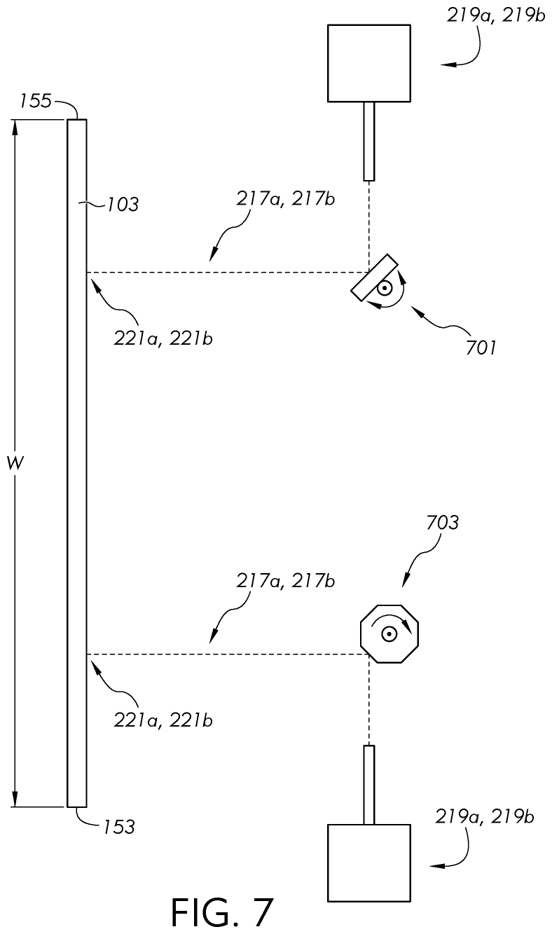

FIG. 7 shows embodiments where one or more laser beams 217a, 217b may be scanned across the width “W” of the glass-based ribbon 103 by way of an oscillating mirror 701 and/or a rotating polygonal mirror 703. Additionally, acousto-optical deflectors can be used to scan the laser beam across the width “W” of the glass-based ribbon 103. In some embodiments, the laser beams may scan across the width while also moving down the travel path, for example at the same velocity of the drawn ribbon, to create the plurality of grooves 815. In further embodiments, a width of a pulse of the laser beam 217a, 217b can be controlled to produce the predetermined design for the plurality of grooves. In some embodiments, the plurality of grooves 815 may be simultaneously formed by a plurality of scanning laser beams. In further embodiments, an angular speed of the mirror(s) and/or a power of the laser can be modulated to selectively heat predetermined locations (e.g., target location(s)) to generate the plurality of grooves 815. In further embodiments, a power of the laser can be modulated in synchronization with the rotation of the polygonal mirror 703 to create the plurality of grooves 815.

For example, using the apparatus of FIG. 7, the plurality of grooves 815 can be formed with the groove length 823 extending in the draw direction 154 when the laser(s) emitting the one or more laser beams 217a, 217b travel in the draw direction 154 at the same speed as the glass-based ribbon 103. A trace across the foldable substrate 803 in the direction 813 can be generated by scanning the laser beam transverse to the draw direction 154 and selectively operated the laser to emit a pulse at each location where a groove is to be located. Then, the one or more laser beams can be realigned with the next trace across the foldable substrate 803 in the direction 813, which can be upstream relative to the draw direction by about a diameter of the laser beam or more from the previous trace. This process can be repeated until the predetermined groove length is obtained.

For example, using the apparatus of FIG. 7, the plurality of grooves can be formed with the groove length 823 extending transverse to the draw direction 154 when the laser(s) emitting the one or more laser beams 217a, 217b travel in the draw direction 154 at the same speed as the glass-based ribbon 103. A trace across the foldable substrate 803 in the direction 809 can be performed by operating (e.g., continuously operating) the laser while scanning the laser beam transverse to the draw direction for the groove length 823. The laser need not be operated for traces in the direction 809 that do not correspond to a groove. Then, the laser and/or one or more laser beams can be aligned with the next trace in the direction 809 containing a groove.

For example, using the apparatus of FIG. 7, the groove 2115 can be generated such that the width 2119 of the central portion 2216 extends in either the draw direction 154 or transverse to the draw direction 154. When the width 2119 extends in the draw direction, the trace that the laser and one or more laser beams reproduces in the direction 2113. When the width 2119 extends transverse to the draw direction 154, the trace that the laser and one or more laser beams reproduces is in the direction 2109. As discussed above, the laser can be translated in the draw direction 154 at the same speed as the glass-based ribbon 154 while scanning transverse to the draw direction with the laser operated such that the one or more laser beams corresponds to the trace to be generated in the direction transverse to the draw direction 154.

Turning back to FIG. 20, the method may end at 2006 sometime after the step 2005 of forming the groove(s) (e.g., plurality of grooves 815, groove 2115). In some embodiments, as indicated by step 2007 and arrow 106 in FIG. 1, the foldable substrate 803 or 2103 may optionally be coiled onto a storage roll as the coiled spool 108 of glass-based ribbon including the central portions 820 including the groove(s) (e.g., plurality of grooves 815, groove 2115). Coiling the drawn glass-based ribbon with the central portions as a coiled spool 108 can facilitate storage of the glass-based ribbon for delivery and/or subsequent processing. As shown by step 2009 in FIG. 20, the method can proceed to separate the glass-based ribbon 103 to provide the foldable substrate 803 or 2103. For example, as shown by arrow 110 in FIG. 1, the glass-based ribbon 103 may be uncoiled from the coiled spool 108 and then separated, for example, with the glass separator 149. Alternatively, as indicated by arrow 2011 in FIG. 20, the foldable substrates 803 or 2103 may be separated from the glass-based ribbon as the glass-based ribbon is being drawn from the forming device 140 by the glass separator 149 positioned downstream from the forming device 140.

Any time after the step 2005 of forming the groove(s) (e.g., plurality of grooves 815, groove 2115), the method can include one or more post-treatment steps 2013 to provide desired properties to the foldable substrate 803 or 2103. For example, the foldable substrate may be placed in an etchant bath to reduce the thickness of the foldable substrate. In further embodiments, the foldable substrate 803 or 2103 can comprise a foldable glass-based substrate and/or a foldable ceramic-based substrate and the post-treatment step 2013 can comprise chemically strengthening the foldable substrate. Chemically strengthening may comprise an ion exchange process, where ions in a surface layer are replaced by—or exchanged with—larger ions having the same valence or oxidation state. A compressive stress region may extend into a portion of the substrate for a depth called the depth of compression. In some embodiments, depth of compression at a location of the foldable substrate can be in a range from about 10% to about 30% of the thickness of the foldable substrate at the location of the foldable substrate, as discussed above.

Chemically strengthening the foldable substrate 803 or 2103 by ion exchange can occur when a first cation within a depth of a surface of a foldable substrate is exchanged with a second cation within a salt solution that has a larger radius than the first cation. For example, a lithium cation within the depth of the surface of the foldable substrate can be exchanged with a sodium cation or potassium cation within a salt solution. Consequently, the surface of the foldable substrate is placed in compression and thereby chemically strengthened by the ion exchange process since the lithium cation has a smaller radius than the radius of the exchanged sodium cation or potassium cation within the salt solution. Chemically strengthening the foldable substrate can comprise contacting at least a portion of a foldable substrate comprising lithium cations and/or sodium cations with a salt bath comprising salt solution comprising potassium nitrate, potassium phosphate, potassium chloride, potassium sulfate, sodium chloride, sodium sulfate, and/or sodium nitrate, whereby lithium cations and/or sodium cations diffuse from the foldable substrate to the salt solution contained in the salt bath. In some embodiments, the temperature of the salt solution can be about 300° C. or more, about 360° C. or more, about 400° C. or more, about 500° C. or less, about 460° C. or less, or about 400° C. or less. In some embodiments, the temperature of the salt solution can be in a range from about 300° C. to about 500° C., from about 360° C. to about 500° C., from about 360° C. to about 460° C., from about 400° C. to about 460° C., from about 300° C. to about 400° C., from about 360° C. to about 400° C., or any range or subrange therebetween. In some embodiments, the substrate can be in contact with the salt solution for about 15 minutes or more, about 1 hour or more, about 3 hours or more, about 48 hours or less, about 24 hours or less, or about 8 hours or less. In some embodiments, the substrate can be in contact with the salt solution for a time in a range from about 15 minutes to about 48 hours, from about 1 hour to about 48 hours, from about 3 hours to about 48 hours, from about 15 minutes to about 24 hours, from about 1 hour to about 24 hours, from about 3 hours to about 48 hours, from about 3 hours to about 24 hours, from about 3 hours to about 8 hours, or any range or subrange therebetween. The ion-exchange process may be performed after the groove(s) (e.g., plurality of grooves 815, groove 2115) is formed in the foldable substrate 803 or 2103.

As shown in FIG. 20, after separating (see arrow 2015) or after post treatment (see arrow 2017), the method can further include the step 2019 of adding additional optional components of the foldable apparatus. For example, as shown in FIG. 10, in some embodiments, the method of making the foldable apparatus 1001 may comprise contacting a first contact surface 1003 of an optically clear adhesive 1005 with the first major surface 903 or 2203 of the foldable substrate 803 or 2103. In some embodiments, the method of making the foldable apparatus can include filling the groove(s) (e.g., plurality of grooves 815, groove 2115) with the optically clear adhesive 1005.

In some embodiments, methods of making the foldable substrate 803 or 2103 and/or foldable apparatus 801, 1001, 1101, 2101, 2302, or 2401 of embodiments of the disclosure may omit the heating step (e.g., step 2007) before impinging the laser on the glass-based substrate to form the plurality of grooves 815 (e.g., by ablation). In some embodiments, methods of making the foldable substrate 803 or 2103 may comprise depositing (e.g., printing) a mask on the first major surface of the glass-based substrate, etching the glass-based substrate by exposing the first major surface of the glass-based substrate to a mineral acid solution to form the groove(s) (e.g., plurality of grooves 815, groove 2115), and removing the mask. In some embodiments, methods of the making the foldable substrate 803 or 2103 can comprise mechanically forming the groove(s) (e.g., plurality of grooves 815, groove 2115). In some embodiments, the foldable substrate 803 or 2103 can comprise a foldable glass-based substrate. In further embodiments, the foldable glass-based substrate may be transformed into a foldable ceramic-based substrate as described above.

### EXAMPLES

Various embodiments will be further clarified by the following modeled examples. The Examples were modeled using Abaqus finite element analysis software from Dassault Systemes Simulia. The modeled examples demonstrate that the designs for the plurality of grooves of embodiments of the disclosure reduce bend-induced stresses in a foldable substrate 803 comprising a plurality of grooves 815 in accordance with embodiments of the disclosure compared to the same substrate without grooves. Bend-induced stresses are reduced by designs for the plurality of grooves when the stress ratio is less than 1. Additionally, the examples demonstrate that the reduction in bend-induced stresses associated with the designs of embodiments of the disclosure are unexpected in light of the numerous designs for a plurality of grooves that do not reduce bend-induced stresses compared to the same substrate without grooves.

All examples in FIGS. 12-19 modeled with substrates and/or foldable substrates comprising glass-based substrates. For each point presented, a foldable substrate comprising a glass-based substrate with a plurality of grooves and a corresponding glass-based substrate without grooves have the same dimensions (e.g., length, width, thickness) and the same material composition. In each design comprising a plurality of grooves, each of the grooves in the design were identical (e.g., same groove depth, groove width, groove length).

In FIGS. 12 and 18-19, the vertical axis (e.g., y-axis) is a stress ratio of a glass-based substrate comprising a predetermined design for the plurality of grooves to a corresponding glass-based substrate without a plurality of grooves. Both the glass-based substrate comprising a plurality of grooves and the corresponding glass-based substrate have the same dimensions (e.g., length, width, thickness) and material composition. In each design comprising a plurality of grooves, each of the grooves in the design were identical (e.g., same groove depth, groove width, groove length). The design for the plurality of grooves reduces the bend-induced stresses when the vertical axis (stress ratio) is less than 1. The bend-induced stresses for all glass-based substrates presented in FIGS. 12 and 18-19 were measured at a parallel plate distance of 10 mm.

FIG. 12 presents the stress ratio as a function of a ratio (Vg/Vc) of the combined groove volume to the central volume. The horizonal axis 1201 (e.g., x-axis) is the ratio (Vg/Vc) of the combined groove volume to the central volume. For FIG. 12, substrate thicknesses 901 of 100 μm and 150 μm were used with a range of different designs (e.g., groove width, groove depth, groove spacing) for the plurality of grooves. As shown in FIG. 12, all designs tested with a ratio (Vg/Vc) less than about 0.2 increase bend-induced stresses, because for those (Vg/Vc) ratios the stress ratio is greater than 1. In fact, the designs tested with a ratio (Vg/Vc) less than 0.1 increased the bend-induced stresses by at least a factor of 2. In contrast, all designs tested with a ratio (Vg/Vc) greater than about 0.4 decrease bend-induced stresses, because for those ratios (Vg/Vc) the stress ratio is less than 1. For designs with a ratio (Vg/Vc) greater than 0.3, one design does not decrease bend-induced stresses. Providing a plurality of grooves in a glass-based substrate with a ration (Vg/Vc) of about 0.3 or more (e.g., about 0.4 or more) can reduce bend-induced stresses.

FIGS. 18-19 present the stress ratio as a function of a ratio (Gw/T) of the groove width 821 to the substrate thickness 901. All designs presented in FIG. 18 comprised a ratio (Gs/T)—of the groove spacing 817 to substrate thickness—of 0.133. All designs presented in FIG. 19 comprised a ratio (Gs/T)—of the groove spacing 817 to substrate thickness—of 1.33. Curves 1801, 1805, 1809, and 1813 correspond to glass-based substrates comprising a thickness of 150 μm while curves 1803, 1807, 1811, and 1815 correspond to glass-based substrates comprising a thickness of 100 μm. Curves 1801 and 1803 correspond to designs comprising a ratio (Gd/T)—of the groove depth 911 to substrate thickness—of 0.33. Curves 1805 and 1807 correspond to designs comprising a ratio (Gd/T)—of the groove depth 911 to substrate thickness—of 0.53. Curves 1809 and 1811 correspond to designs comprising a ratio (Gd/T)—of the groove depth 911 to substrate thickness—of 0.67. Curves 1813 and 1815 correspond to designs comprising a ratio (Gd/T)—of the groove depth 911 to substrate thickness—of 0.8.

In FIG. 18, all of the curves contain at least one point where the stress ratio is less than 1. For curves 1801 and 1803, the point for the ratio (Gw/T) of 1.33 has a stress ratio less than 1. For curves 1805 and 1807, the stress ratio is less than 1 when the ratio (Gw/T) is 0.67 or more. For curves 1809 and 1811, the stress ratio is less than 1 for the ratio (Gw/T) of about 0.4 or more. For curves 1813 and 1815, the stress ratio is less than 1 for all values shown. As such, a stress reduction can be obtained for a ratio (Gd/T) of about 0.3 or more. Likewise, a stress reduction can be obtained for a ratio (Gw/T) of 0.1 or more. Further, the stress reductions increase as (Gd/T) increases and as (Gw/T) increases.

In FIG. 19, curve 1813 comprises a point where the stress ratio is less than 1, namely for the ratio (Gw/T) of 1.33. This is in stark contrast to FIG. 18, where all of the curves contained at least one point where the stress ratio is less than 1. Curves with intermediate values of the ratio (Gs/T) from 0.133 (FIGS. 18) to 1.33 (FIG. 19) show a smooth trend of decreasing stress ratios as Gs/T decreases (see FIGS. 13-16 for more details). However, it appears that a stress ratio less than 1 could still be obtained out to a ratio (Gs/T) of about 1.5 (for at least some values of (Gd/T)) since FIG. 19 corresponding to a ratio (Gs/T) of 1.33 comprises curve 1813 with points where stress ratios less than 1 and the decreasing trend discussed above can be used to extrapolate this behavior.

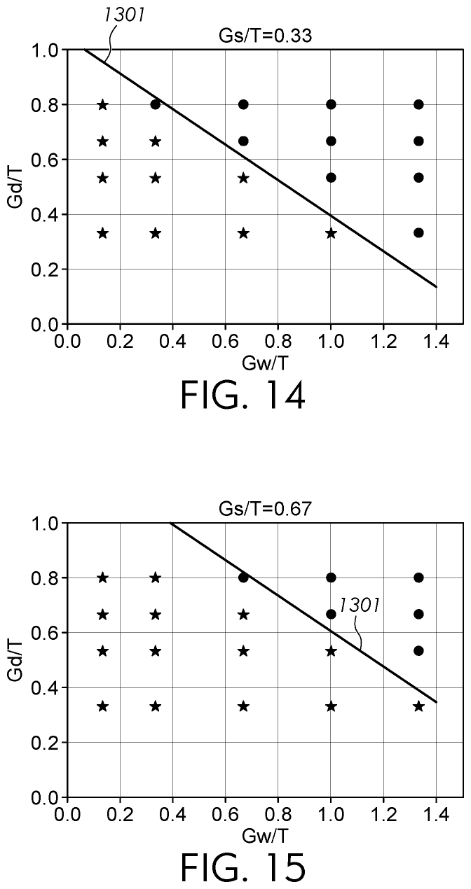

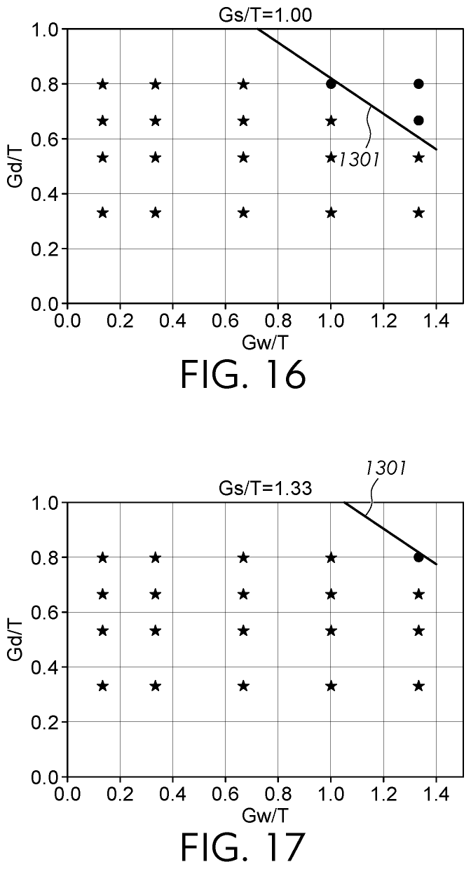

FIGS. 13-17 plot various designs tested with a circle if the stress ratio is greater than 1 or a start if the stress ratio is less than 1. The points with a stress ratio less than 1 mean that the stress is reduced by including the plurality of grooves with the specified design. FIG. 13-17 show points as a function of the ratio (Gd/T) and (Gw/T). In FIG. 13, the ratio (Gs/T) is 0.13. In FIG. 14, the ratio (Gs/T) is 0.33. In FIG. 15, the ratio (Gs/T) is 0.67. In FIG. 16, the ratio (Gs/T) is 1.00. In FIG. 17, the ratio (Gs/T) is 1.33.

Curve 1301 corresponds to the expression 7.93-6.19*(Gw/T) −9.52*(Gd/T) +6.05*(Gs/T)=0, which was fitted to separate regions comprising a stress ratio greater than 1 from regions comprising a stress ratio less than 1. In FIGS. 13-17, each plot contains a point where the stress ratio is greater than 1 (circle) that is below curve 1301 but is close to the curve, demonstrating that the curve 1301 is a good discriminator of where the switch from stress ratios less than 1 to stress ratios greater than 1 occurs. Of the points measured between FIGS. 13-17 to the left and/or below the curve 1301, less than 7% (5/72) of the points show a stress increase. Indeed, if points further to the left and/or below those measured were included or if points were measured at Gw/T=0.5, the % of points showing a stress increase would be less. As such, substantially all designs satisfying the expression 0.93-6.19*(Gw/T) −9.52*(Gd/T) +6.05*(Gs/T) <0 can provide stress reductions, which corresponds to the region to the left and/or below curve 1301. A design relationship that can reduce the stress through the inclusion of a plurality of grooves is an unexpected result and technical benefit.

Embodiments of the disclosure can comprise a consumer electronic product. The consumer electronic product can comprise a front surface, a back surface and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In some embodiments, at least one of a portion of the housing or the cover substrate comprises the foldable apparatus discussed throughout the disclosure.

A foldable apparatus according embodiments of the disclosure can provide several technical benefits. A foldable apparatus comprising a plurality of grooves in a foldable substrate according to embodiments of the disclosure can reduce bend-induced stresses on the foldable substrate compared to a corresponding foldable substrate without grooves. Reduced bend-induced stresses can provide the technical benefit of increased folding performance, for example, lower effective minimum bend radii (e.g., about 10 millimeters or less). Reduced bend-induced stresses can facilitate the use of thicker foldable substrates that obtain a predetermined effective bend radius, which can enable good impact and/or puncture resistance. Providing a plurality of grooves comprising a ratio (Gs/T) of about 1.5 or less, a ratio (Gd/T) in a range from about 0.3 to about 0.95, a ratio (Gw/T) of about 0.3 or more, or combinations thereof can provide reduced bend-induced stresses. Providing a plurality of grooves in a foldable substrate satisfying the expression 7.93-6.19*(Gw/T) −9.52*(Gd/T) +6.05*(Gs/T) <0 can provide bend-induced stress reductions. Providing a plurality of grooves such that a ratio (Vg/Vc) of the combined groove volume to the central volume of about 0.3 or more can provide bend-induced stress reductions. Additionally, chemically strengthening the foldable substrate (e.g., central portion of the substrate) can provide the technical benefit of improved effective minimum bend radii and/or reduced damages (e.g., breakage and/or cracking) of the foldable apparatus because the compressive stress from chemical strengthening can counteract tensile bend-induced forces. Also, providing a central portion with the second thickness and a width that is about 3 times or more (e.g., 4.4 times) the effective minimum bend radius (e.g., bend length) or more can reduce stress concentrations and damage to the foldable apparatus. Matching (e.g., within about 0.1) the index of refraction of the optically clear adhesive to the index of refraction of the foldable substrate can minimize optical distortions in the foldable apparatus.

Also, methods of making a foldable apparatus can reduce or eliminate surface damage in a substrate (e.g., a glass-based and/or a ceramic-based substrate) that may otherwise be formed with conventional techniques. In some embodiments, ablation of the glass-based substrate to form the grooves can be carried out by impinging a target location of the substrate with a laser beam, wherein the target location of the glass-based substrate is at a heated temperature of 500° C. or more when initially beginning to impinge the target location with the laser beam. The heated temperature of the substrate can help partially or completely heal surface damage caused by the laser ablation procedure since the heated temperature of the target location at the time the laser ablation occurs can allow portions of the substrate to flow to partially or entirely erase and/or heal and/or reduce the surface damage or other residual imperfections caused by the laser ablation process. In addition, the groove(s) can be formed in-line with a method of forming a ribbon to reduce the steps to form the grooves. Furthermore, as the groove(s) are formed in-line with the ribbon-forming process, in some embodiments, rather than separating single foldable substrates from the ribbon after forming the groove(s), a single ribbon can be rolled into a storage roll with the grooves already formed in the ribbon. Later, the ribbon may be unwound from the storage roll and separated into individual foldable substrates. A single storage roll may, therefore, be easily stored where the individual foldable substrates may then be separated from the ribbon unwound from the storage roll when desired. Furthermore, when unwinding the ribbon, the number of central portions may be selected for each individual foldable substrate at the time of unwinding the ribbon from the storage roll. As such, a bifold foldable substrate, trifold foldable substrate, or other foldable substrate arrangements may be selected at the time of unwinding the ribbon from the storage roll.

Directional terms as used herein—for example, up, down, right, left, front, back, top, bottom—are made only with reference to the figures as drawn and are not intended to imply absolute orientation.

It will be appreciated that the various disclosed embodiments may involve features, elements, or steps that are described in connection with that embodiment. It will also be appreciated that a feature, element, or step, although described in relation to one embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises embodiments having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C. As used herein, the terms “comprising” and “including”, and variations thereof shall be construed as synonymous and open-ended unless otherwise indicated.

The above embodiments, and the features of those embodiments, are exemplary and can be provided alone or in any combination with any one or more features of other embodiments provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the embodiments herein provided they come within the scope of the appended claims and their equivalents.

What is claimed is:

1. A foldable apparatus comprising a foldable substrate foldable about an axis extending in a direction of a width of the foldable substrate, the foldable substrate further comprising:
a first major surface, a second major surface, and a thickness (T) defined between the first major surface and the second major surface;
a central portion comprising a plurality of grooves extending through the first major surface;
a groove spacing (Gs) defined between a pair of grooves of the plurality of grooves; and
a first groove of the plurality of grooves comprising a groove depth (Gd) in a direction of the thickness (T), a groove length in the direction of the width of the foldable substrate, and a groove width (Gw) in a direction of a length of the foldable substrate that is perpendicular to the width of the foldable substrate,
wherein 7.93-6.19*(Gw/T) −9.52*(Gd/T) +6.05*(Gs/T) <0.

2. The foldable apparatus of claim 1, wherein the ratio (Gw/T) is about 0.1 or more.

3. The foldable apparatus of claim 1, wherein the ratio (Gs/T) is about 1.5 or less.

4. The foldable apparatus of claim 1, wherein the ratio (Gd/T) is in a range from about 0.3 to about 0.95.

5. The foldable apparatus of claim 1, wherein the first major surface extends along a first plane, the second major surface extends along a second plane parallel to the first plane, and the foldable apparatus further comprises:
a combined groove volume (Vg) comprising a sum of a volume of each groove of the plurality of grooves bounded by the first plane and circumscribed by an outer periphery of the central portion; and
a central volume (Vc) defined between the first plane and the second plane and circumscribed by the outer periphery of the central portion, wherein a ratio (Vg/Vc) of the combined groove volume (Vg) to the central volume (Vc) is about 0.3 or more.

6. The foldable apparatus of claim 1, wherein the first groove comprises a cross-sectional profile taken perpendicular to the groove length that is substantially identical at ten (10) locations equidistantly spaced along the entire groove length.

7. The foldable apparatus of claim 1, wherein the first groove is substantially parallel to a second groove of the plurality of grooves.

8. The foldable apparatus of claim 1, wherein the thickness (T) is in a range from about 100 micrometers to about 3 millimeters.

9. The foldable apparatus of claim 1, wherein the first groove is defined by a groove surface, and a minimum distance between the groove surface and the second major surface is in a range from about 20 micrometers to about 100 micrometers.

10. The foldable apparatus of claim 1, wherein the groove width (Gw) is in a range from about 20 micrometers to about 200 micrometers.

11. The foldable apparatus of claim 1, wherein the groove length is equal to the width of the foldable substrate.

12. The foldable apparatus of claim 1, wherein the foldable substrate comprises a glass-based substrate.

13. The foldable apparatus of claim 1, wherein the foldable substrate comprises an effective minimum bend radius in a range from about 1 millimeter to about 10 millimeters.

14. The foldable apparatus of claim 1, wherein a central width of the central portion the direction of the length of the foldable substrate is in a range from about 0.5 millimeters to about 50 millimeters.

15. The foldable apparatus of claim 1, further comprising an optically clear adhesive comprising a first contact surface contacting the first major surface and the optically clear adhesive fills the first groove.

16. A method of making a foldable apparatus comprising:
heating a ribbon to a heated temperature of 500° C. or more;
emitting a laser beam from a laser;
impinging a target location of the ribbon with the laser beam to form a groove in the ribbon, wherein the ribbon forms a foldable substrate, and the target location of the foldable substrate is at the heated temperature when initially beginning to impinge the target location with the laser beam,
wherein a thickness of the foldable substrate is defined between a first major surface of the foldable substrate and a second major surface of the foldable substrate opposite the first major surface, the groove of the foldable substrate comprising a groove depth in a direction of the thickness, the groove depth is in a range from about 10 micrometers to about 95% of the thickness of the foldable substrate.

17. The method of claim 16, wherein forming the groove comprises forming a plurality of grooves and impinging the target location comprises impinging a plurality of target locations of the ribbon with the laser beam.

18. The method of claim 16, wherein the target location of the ribbon comprises a viscosity in a range from about 10¹¹ Pascal-seconds to about 10¹⁴ Pascal-seconds when initially beginning to impinge the target location with the laser beam.

19. The method of claim 16, wherein impinging the target location with the laser beam ablates the ribbon at the target location to form the groove.

20. The method of claim 16, further comprising contacting a first contact surface of an optically clear adhesive with the first major surface, and the optically clear adhesive fills the groove.
